(19) United States
(12) Patent Application Publication
(10) Pub. No.: US 2023/0294123 A1
(43) Pub. Date: Sep. 21, 2023

(54) One-piece-single-unit device of combined vertical scoop-funnel-disposable cup container mate component

(71) Applicant: Hossein Jolani, O'Fallon, IL (US)

(72) Inventor: Hossein Jolani, O'Fallon, IL (US)

(21) Appl. No.: 17/803,219

(22) Filed: Mar. 18, 2022

(51) Int. Cl. B05C 5/00; B44D 3/12; B05C 11/11

(52) U.S. Cl. CPC B05C 5/00; B44D 3/12; B05C 11/11

(57) ABSTRACT

A flowable material particularly liquid paint that can be transferred or poured from a standard external disposable cup container to the remote external surface in particular a canvas or any other desired surface with the great extent of detailed control along with precision, and efficiency and also along with creating a variety of designs, textures, patterns and styles in the process of pouring by using a one-piece-single-unit device which is made of extended and connected combinations of a vertical cup container, a vertical semi-cone shape funnel, a vertical cylinder funnel, and a vertical top adjacent scoop along with an extended and connected to a flat squared surface section which has a straight-line top end edge section that is made as a one-piece-single-unit device and which is constructed by an extended and connected components from the bottom up with the construction of a vertically positioned container's cup shape with a connected off-vertical flat parallelogram shaped handle, which can hold a disposable cup with the flowable material, with the wide top opening edge which is being faced upward and the bottom container's cup shape being faced downward and being closed thereof is extended and connected to a vertically transition semi-cone shape funnel component, that is in a transition area, which having a semi-cone shape funnel body wall with the semi-cone shape funnel's wider opening end facing downward, and a semi-cone shape funnel's narrow opening end which is facing upward that is extending and connecting to the top container's cup shape container wide opening end from one end and extending and connecting to the vertical cylinder funnel bottom opening end from another end which in transition semi-cone shape funnel and cylinder funnel body wall with having a vertical straight even back body wall thereof with the construction of a vertically positioned cylinder funnel components, transportation areas, and with having two even size opening ends with the bottom end opening thereof extended and connected to the top opening end edge of the semi-cone shape funnel from one end and extended and connected to the bottom opening end of the vertical adjacent scoop from another end, which is for extracting the liquid material, along with the extended flat square surface section which is being used to pass the flowable material over the extended flat squared surface section which has a straight-line top end edge section, which is for creating a new texture, and pattern and so on as the main source is changing the top end edge shape, for the pouring function process, so wherein an external standard cup which contains flowable material can be placed vertically inside the vertically positioned container's cup shape compartment and then by holding and bringing the entire one-piece-single-unit device in a horizontal or near horizontal position by moving in a very small scale to the off and on horizontal level will allow the liquid material being extracted with the great extent of detailed control, precision, and efficiency along with creating new designs, textures, patterns, and styles of pouring the liquid material in any desired particular liquid paint on a canvas or any desired surface.

### FIELD OF INVENTION

The present invention relates to the flowable material particularly liquid with disposable cup used for pouring function. More specifically, the present invention relates to pouring artist using a disposable cup for pouring liquid paint on a canvas or any surface.

### BACKGROUND OF INVENTION

Most pouring artists are using a disposable cup with a liquid paint after being adjusted to the artists proper desired consistency by using water or other liquid medium materials, then the artist pours the liquid paint which is inside the disposable cup on to the canvas or any other desired surface, but if the canvas has drawn pictures or figures and so on, pouring with disposable cup does not work well, because the artist has less or any detail or precision control on the amount of paint that flows from the disposable cup and also having less choice of style, pattern, texture or design of pouring of liquid paint from the disposable cup on to the canvas, which is extremely limited in the pouring process by the pouring artist. It also a takes lesser angle level for the direct use of a disposable cup for the poring process and that means a lesser control angle by the artist or any other users.

### BRIEF SUMMARY OF INVENTION

The primary objective of the present invention are as follows: The first objective is by giving the pouring artist more control on quantity and quality their of detail of pouring and a more precise pouring along with a more creative variety of patterns, textures, designs and styles in the world of paint pouring art; The second objective is for the present device that it can be used directly with a more flowable material with more particularly the artist liquid paint and can be washed and used over and over and also can be used indirectly with the general disposable cup for this pouring function; The third objective is to give the pouring artist options to manipulate the mix-paint from the time the liquid paint travels from the cup section to the extracted top edge point of the scoop's funnel section of this present invention, by a variety of the artist's selective and chosen functions and this is where the unique styles, textures, designs, and patterns of each artists pouring will be born and created; The forth objective is by having the extracted top edge point of the scoop's funnel section with a straight or curve line and even angle pointed tip along with a variety of patterns, shapes and designs which creates a variety of textures. It must be reminded that by using a vertical, it refers to upright position and by using a horizontal, it refers to straight and level position and also by using top end position which being referenced to as top, bottom, left, right, front, back positions and so on in the following brief and detail description of drawings and claims writing.

### BRIEF DESCRIPTION OF DRAWING

The accompanying drawings, which are incorporated in and constitute a part of the specification, illustrated embodiments of the invention and together with the description and serve to explain the principle of the invention.

FIG. 1 is a perspective view of a one-piece-single-unit device of a combined vertical scoop-funnel-disposable cup container mate component, in accordance with an embodiment of the present invention.

FIG. 2 is a perspective view of a one-piece-single-unit device of combined vertical scoop-funnel-disposable cup container mate component with an open-end cup container mate section, in accordance with an embodiment of the present invention.

FIG. 3 is a perspective view of a one-piece-single-unit device of combined vertical scoop-funnel-disposable cup container mate component with a cup container mate section without a handle, in accordance with an embodiment of the present invention.

FIG. 4 is a perspective view of a one-piece-single-unit device of combined vertical scoop-funnel-disposable cup container mate component without top second adjacent scoop along with an extended flat square surface section which has a top end straight line edge section and an open-end cup container mate section, in accordance with an embodiment of the present invention.

FIG. 5 is a perspective view of an attachable second scoop funnel head along with an extended flat square surface section which has a straight series of a connected top end evenly spaced and sized beveled edge section, in accordance with an embodiment of the present invention.

FIG. 6 is a perspective view of a one-piece-single-unit device of combined with a vertical scoop-funnel-disposable cup container mate component with an open-end cup container mate section and a connected by an attachable second scoop funnel head which has a straight series of a connected top end evenly spaced and sized beveled edge section, in accordance with an embodiment of the present invention.

FIG. 7 is a perspective view of a one-piece-single-unit device of a combined vertical scoop-funnel-disposable cup container mate component with a semi-cylindrical funnel, in accordance with an embodiment of the present invention.

FIG. 8 is a perspective view of a one-piece-single-unit device of a combined vertical scoop-funnel-disposable cup container mate component with a semi-cylindrical funnel, and with the cup container mate section without a handle, in accordance with an embodiment of the present invention.

FIG. 9 is a perspective view of a one-piece-single-unit device of a combined vertical scoop-funnel-disposable cup container mate component with a rectangular-prism shaped funnel with a top end rectangular-prism angle cut scoop which has a top end straight line edge section, in accordance with an embodiment of the present invention.

FIG. 10 is a perspective view of a one-piece-single-unit device of a combined vertical scoop-funnel-disposable cup container mate component with a vertical staple shape funnel with the top end staple shape angle cut adjacent scoop along with an extended top end flat square section which has a top end straight line edge section, in accordance with an embodiment of the present invention.

FIG. 11 is a perspective view of a one-piece-single-unit device of a combined vertical scoop-funnel-disposable cup container mate component with a triangular-prism shaped funnel with a top end triangular-prism angle cut adjacent scoop which has a top end V shape pointed tip section, in accordance with an embodiment of the present invention.

FIG. 12 is a perspective view of a one-piece-single-unit device of a combined vertical scoop-funnel-disposable cup container mate component with a V shaped funnel with a top end V shaped angle cut adjacent scoop which has a top end V shape pointed tip section, in accordance with an embodiment of the present invention.

FIG. 13 is a perspective view of a one-piece-single-unit device of a combined vertical scoop-funnel-disposable cup container mate component with a rectangular-prism shaped funnel with a top end rectangular-prism angle cut adjacent scoop along with an extended top end flat square section which has a top end straight line edge section, in accordance with an embodiment of the present invention.

FIG. 14 is a perspective view of a one-piece-single-unit device of a combined vertical scoop-funnel-disposable cup container mate component with a rectangular-prism shaped funnel without a top adjacent scoop along with an extended flat square surface section which has a top end straight line edge section, in accordance with an embodiment of the present invention.

FIG. 15 is a perspective view of an attachable second rectangular-prism shaped scoop funnel head along with an extended flat square surface section which has a straight series of a connected top end evenly spaced and sized beveled edge section, in accordance with an embodiment of the present invention.

FIG. 16 is a perspective view of a one-piece-single-unit device of combined vertical scoop-funnel-disposable cup container mate component with a connected an attachable second rectangular-prism shaped scoop funnel head along with an extended flat square surface section which has a straight series of a connected top end evenly spaced and sized beveled edge section, in accordance with an embodiment of the present invention.

FIG. 17 is a perspective view of a one-piece-single-unit device of a combined vertical scoop-funnel-disposable cup container mate component with the top adjacent scoop, along with an extended and connected top end flat square section which has a straight series of a connected top end evenly spaced and sized square angled edge section, in accordance with an embodiment of the present invention.

FIG. 18 is a perspective view of a one-piece-single-unit device of a combined vertical scoop-funnel-disposable cup container mate component with the top adjacent scoop, along with an extended and connected top end flat square section which has a straight series of a connected top end evenly spaced and sized chisel beveled edge section, in accordance with an embodiment of the present invention.

FIG. 19 is a perspective view of a one-piece-single-unit device of a combined vertical scoop-funnel-disposable cup container mate component with the top adjacent scoop, along with an extended and connected top end flat square section which has a protruding series of a top end evenly spaced, unevenly sized and unorganized strip edge section, in accordance with an embodiment of the present invention.

FIG. 20 is a perspective view of a one-piece-single-unit device of combined of a vertical scoop-funnel-disposable cup container mate component with the top adjacent scoop, along with an extended and connected top end flat semi-square section which has an extended top end single bevel edge section, in accordance with an embodiment of the present invention.

FIG. 21 is a perspective view of a one-piece-single-unit device of a combined vertical scoop-funnel-disposable cup container mate component with the top adjacent scoop, along with an extended and connected top end flat square section which has an extended top end semi-circle edge section, in accordance with an embodiment of the present invention.

FIG. 22 is a perspective view of a one-piece-single-unit device of a combined vertical scoop-funnel-disposable cup container mate component with the top adjacent scoop, along with an extended and connected top end flat square section which has an extended top end semi-circle edge section along with a protruding fan shape series of a top end evenly spaced, unevenly sized, and organized strip edge section, in accordance with an embodiment of the present invention.

FIG. 23 is a perspective view of a one-piece-single-unit device of a combined vertical scoop-funnel-disposable cup container mate component with the top adjacent scoop, along with an extended and connected top end flat semi-square section which has an extended top end single chisel bevel edge section, in accordance with an embodiment of the present invention.

FIG. 24 is a perspective view of a one-piece-single-unit device of a combined vertical scoop-funnel-disposable cup container mate component with the top adjacent scoop, along with an extended and connected top end flat square section which has an extended top end wave shaped line edge section, in accordance with an embodiment of the present invention.

FIG. 25 is a perspective view of a one-piece-single-unit device of a combined vertical scoop-funnel-disposable cup container mate component with the top adjacent scoop, along with an extended and connected top end flat square section which has a straight series of a connected top end evenly spaced and sized beveled edge section, in accordance with an embodiment of the present invention.

FIG. 26 is a perspective view of an attachable second scoop funnel head along with an extended top end flat square section which has an extended top end wave shaped line edge section, in accordance with an embodiment of the present invention.

FIG. 27 is a perspective view of an attachable second scoop funnel head along with an extended top end flat square section which has a top end straight line edge section, in accordance with an embodiment of the present invention.

FIG. 28 is a perspective view of an attachable second scoop funnel head along with an extended top end flat square section which has a straight series of a connected top end evenly spaced and sized square angled edge section, in accordance with an embodiment of the present invention.

FIG. 29 is a perspective view of an attachable second scoop funnel head along with an extended top end flat square section which has a straight series of a connected top end evenly spaced and sized chisel beveled edge section, in accordance with an embodiment of the present invention.

FIG. 30 is a perspective view of an attachable second scoop funnel head along with an extended top end flat square section which has a protruding series of a top end evenly spaced, unevenly sized and unorganized strip edge section, in accordance with an embodiment of the present invention.

FIG. 31 is a perspective view of an attachable second scoop funnel head along with an extended top end flat semi-square section which has an extended top end single bevel edge section, in accordance with an embodiment of the present invention.

FIG. 32 is a perspective view of an attachable second scoop funnel head along with an extended top end flat square section which has an extended top end semi-circle edge section, in accordance with an embodiment of the present invention.

FIG. 33 is a perspective view of an attachable second scoop funnel head along with an extended top end flat square section which has an extended top end semi-circle edge section along with a protruding fan shape series of a top end evenly spaced, unevenly sized, and organized strip edge section, in accordance with an embodiment of the present invention.

FIG. 34 is a perspective view of an attachable second scoop funnel head along with an extended top end flat semi-square section which has an extended top end single chisel bevel edge section, in accordance with an embodiment of the present invention.

FIG. 35 is a perspective view of an attachable second rectangular-prism shape scoop funnel head along with an extended top end flat square section which has a straight series of a connected top end evenly spaced and sized chisel beveled edge section, in accordance with an embodiment of the present invention.

FIG. 36 is a perspective view of an attachable second rectangular-prism shape scoop funnel head along with an extended top end flat square section which has a protruding series of a top end evenly spaced, unevenly sized and unorganized strip edge section, in accordance with an embodiment of the present invention.

FIG. 37 is a perspective view of an attachable second rectangular-prism shape scoop funnel head along with an extended top end flat square section which has an extended top end single chisel bevel edge section, in accordance with an embodiment of the present invention.

FIG. 38 is a perspective view of an attachable second rectangular-prism shape scoop funnel head along with an extended top end flat square section which has an extended top end semi-circle edge section, in accordance with an embodiment of the present invention.

FIG. 39 is a perspective view of an attachable second rectangular-prism shape scoop funnel head along with an extended top end flat square section which has an extended top end semi-circle edge section along with a protruding fan shape series of a top end evenly spaced, unevenly sized, and organized strip edge section, in accordance with an embodiment of the present invention.

FIG. 40 is a perspective view of an attachable second rectangular-prism shape scoop funnel head along with an extended top end flat square section which has a top end straight line edge section, in accordance with an embodiment of the present invention.

FIG. 41 is a perspective view of an attachable second rectangular-prism shape scoop funnel head along with an extended top end flat semi-square section which has an extended top end single V shaped bevel edge section, in accordance with an embodiment of the present invention.

FIG. 42 is a perspective view of an attachable second rectangular-prism shape scoop funnel head along with an extended top end flat square section which has a straight series of a connected top end evenly spaced and sized square angled edge section, in accordance with an embodiment of the present invention.

FIG. 43 is a perspective view of an attachable second rectangular-prism shape scoop funnel head along with an extended top end flat square section which has an extended top end wave shaped line edge section, in accordance with an embodiment of the present invention.

FIG. 44 is a perspective view of a one-piece-single-unit device of a combined vertical scoop-funnel-disposable cup container mate component with a top full-elliptical opened adjacent scoop which has a top end curved line edge section, in accordance with an embodiment of the present invention.

FIG. 45 is a perspective view of a one-piece-single-unit device of a combined vertical scoop-funnel-disposable cup container mate component with a top semi-elliptical opened adjacent scoop which has a top end straight line edge section, in accordance with an embodiment of the present invention.

FIG. 46 is a perspective view of a one-piece-single-unit device of a combined vertical scoop-funnel-disposable cup container mate component with having an uneven internal surface tube, in accordance with an embodiment of the present invention.

FIG. 47 shows the FIG. 1 pouring flowable material from a disposable cup through the funnel by passing over the scoop's top end edge on an external surface in a horizontal level position.

FIG. 48 is a perspective view of a one-piece-single-unit device of a combined vertical scoop-funnel-disposable cup container mate component with a vertical staple shaped funnel with a top end staple shape angle cut adjacent scoop which has a top end straight line edge section, in accordance with an embodiment of the present invention.

FIG. 49 is a perspective view of a one-piece-single-unit device of a combined vertical scoop-funnel-disposable cup container mate component with a top full-elliptical opened adjacent scoop along with a top end curved line edge which has a protruding fan shape series of a top end evenly spaced, unevenly sized and organized strip edge section, in accordance with an embodiment of the present invention.

FIG. 50 is a perspective view of a one-piece-single-unit device of a combined vertical scoop-funnel-disposable cup container mate component along with a top vertical adjacent incomplete-elliptical opened scoop which has an extended fan shape series of a top end evenly spaced and sized square angled edge section, in accordance with an embodiment of the present invention.

FIG. 51 is a perspective view of a one-piece-single-unit device of a combined vertical scoop-funnel-disposable cup container mate component along with a top vertical adjacent incomplete-elliptical opened scoop which has an extended fan shape series of a connected top end evenly spaced and sized chisel beveled edge section, in accordance with an embodiment of the present invention.

FIG. 52 is a perspective view of a one-piece-single-unit device of a combined vertical scoop-funnel-disposable cup container mate component along with a top vertical adjacent full-elliptical opened scoop which has a protruding fan shape series of a top end evenly spaced, unevenly sized and unorganized strip edge section, in accordance with an embodiment of the present invention.

FIG. 53 is a perspective view of a one-piece-single-unit device of a combined vertical scoop-funnel-disposable cup container mate component along with a top vertical adjacent incomplete-elliptical opened scoop which has an extended top end single V shaped bevel edge section, in accordance with an embodiment of the present invention.

FIG. 54 is a perspective view of a one-piece-single-unit device of a combined vertical scoop-funnel-disposable cup container mate component along with a top vertical adjacent incomplete-elliptical opened scoop which has an extended top end semi-circle edge section, in accordance with an embodiment of the present invention.

FIG. 55 is a perspective view of a one-piece-single-unit device of a combined vertical scoop-funnel-disposable cup container mate component along with a top vertical adjacent full-elliptical opened scoop which has a protruding fan shape series of a top end evenly spaced, unevenly sized and organized strip edge section, in accordance with an embodiment of the present invention.

FIG. 56 is a perspective view of a one-piece-single-unit device of a combined vertical scoop-funnel-disposable cup container mate component along with a top vertical adjacent incomplete-elliptical opened scoop which has an extended fan shape series of a connected top end evenly spaced and sized V shaped bevel edge section, in accordance with an embodiment of the present invention.

FIG. 57 is a perspective view of a one-piece-single-unit device of a combined vertical scoop-funnel-disposable cup container mate component along with a top vertical adjacent incomplete-elliptical opened scoop which has an extended fan shape series of a connected top end evenly spaced and sized wave angle edge section, in accordance with an embodiment of the present invention.

FIG. 58 is a perspective view of a one-piece-single-unit device of a combined vertical scoop-funnel-disposable cup container mate component along with a top vertical adjacent incomplete-elliptical opened scoop which has an extended top end single chisel bevel edge section, in accordance with an embodiment of the present invention.

FIG. 59 is a perspective view of an attachable second scoop funnel head along with a top vertical adjacent incomplete-elliptical opened scoop which has an extended fan shape series of a top end evenly spaced and sized square angled edge section, in accordance with an embodiment of the present invention.

FIG. 60 is a perspective view of an attachable second scoop funnel head along with a top vertical adjacent incomplete-elliptical opened scoop which has an extended fan shape series of a connected top end evenly spaced and sized chisel beveled edge section, in accordance with an embodiment of the present invention.

FIG. 61 is a perspective view of an attachable second scoop funnel head along with a top vertical adjacent full-elliptical opened scoop which has a protruding series of a top end evenly spaced, unevenly sized and unorganized strip edge section, in accordance with an embodiment of the present invention.

FIG. 62 is a perspective view of an attachable second scoop funnel head along with a top vertical adjacent incomplete-elliptical opened scoop which has an extended top end single V shaped bevel edge section, in accordance with an embodiment of the present invention.

FIG. 63 is a perspective view of an attachable second scoop funnel head along with a top vertical adjacent incomplete-elliptical opened scoop which has an extended top end semi-circle edge section, in accordance with an embodiment of the present invention.

FIG. 64 is a perspective view of an attachable second scoop funnel head along with a top vertical adjacent full-elliptical opened scoop which has a protruding fan shape series of a top end evenly spaced, unevenly sized and organized strip edge section, in accordance with an embodiment of the present invention.

FIG. 65 is a perspective view of an attachable second scoop funnel head along with a top vertical adjacent incomplete-elliptical opened scoop which has an extended fan shape series of a connected top end evenly spaced and sized V shaped bevel edge section, in accordance with an embodiment of the present invention.

FIG. 66 is a perspective view of an attachable second scoop funnel head along with a top vertical adjacent incomplete-elliptical opened scoop which has an extended fan shape series of a connected top end evenly spaced and sized wave angle edge section, in accordance with an embodiment of the present invention.

FIG. 67 is a perspective view of an attachable second scoop funnel head along with a top vertical adjacent incomplete-elliptical opened scoop which has an extended top end single chisel bevel edge section, in accordance with an embodiment of the present invention.

### DETAIL DESCRIPTION OF DRAWING

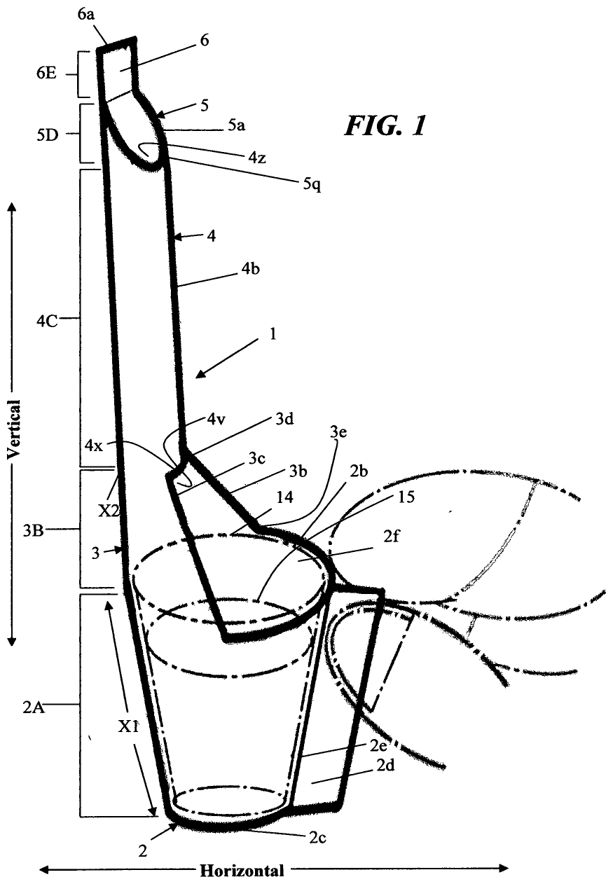

Referring to FIG. 1 is showing a device 1 which is used for pouring flowable material 15 particularly liquid paint in our case from an external disposable standard cup 14 on the external surface in our case is a canvas with having semi-control on detailed pouring with having style and it is important to mention the components being connected in vertical standing and being used in horizontal off and on level positions to get the best result in pouring liquid materials and functions which are shown in a few drawings.

FIG. 1 is showing a device 1 which is made of five vertically extended and connected components are as follows; a vertical cup container section 2A, a vertical semi-cone shaped funnel section 3B, a vertical cylinder funnel section 4C, and a vertical top adjacent scoop section 5D along with an extended flat square surface section 6E which has a top end straight line edge 6a section, which is all made in a one-piece-single-unit device 1. The first combined section which is a vertical cup container 2 component structure 2A which is made with a hollow tube 2, with ring-shaped side wall 2e, with bottom end 2c which is closed and top end 2f to some extent open and easy to get to and place a disposable cup 14 with flowable material 15 inside the vertical cup container's hollow tube 2 and over all the vertical cup container 2 component structure section 2A is having circumferential dimension with wider ring-shaped portion shown near to the top opening edge 2b of the vertical cup container 2 component section 2A and with narrower ring-shaped portion shown near to the bottom closed end edge 2c of the vertical cup container component section 2A which is also having an extended and connected off-vertical flat parallelogram shape handle 2d which starts from the top opening 2f edge 2b to the bottom closed end edge 2c of the vertical cup container component section 2A, which the vertical cup container section 2A is extended and connected to the vertical semi-cone shape funnel 3 component structure 3B. The second combined section which is a vertical semi-cone shape funnel 3 component structure 3B which is made with a deep bowl shape 3 and angle cut-way inclined edge bodies 3b and 3c, and having top narrower opening end 3d which is joined to the vertical cylinder shape funnel 4 of the vertical cylinder shape funnel component structure 4C by connection of top narrower opening end 3d to funnel bottom opening end 4x, and bottom wider opening end 3e, by connection of the bottom wider opening end 3e to vertical cup container wider opening end 2b, which opening 2f allows a disposable cup 14 being placed in cup container 2 through the opening 2f and semi-cone shape funnel section 3B with the deep bowl shape body 3 functions as a transition area for flow of the liquid material 15 between cup container section 2A and cylinder shape funnel 4, which the vertical semi-cone shape funnel section 3B is extended and is connected to the cylinder shape funnel 4 section 4C. The third combined section which is a vertical cylinder shape funnel 4 component structure 4C which is made with a hollow cylinder shape tube 4 which is having circumferential dimension with an even ring-shaped portion, with having top first opening end 4z and bottom second opening end 4v which the bottom second opening end 4v is joined to the vertical semi-cone shape funnel 3 section 3B by connection of the bottom end opening 3d, and the top first opening end 4z is joined to the adjacent scoop 5 component structure 5D by connection of the top first opening end 4z to the scoop 5 bottom opening end 5q, which vertical cylinder shape funnel 4 component structure 4C with having a cylinder shape tube 4 allows liquid material travel and manipulation of liquid material 15 (in particular liquid paints) can happen by changes in the length and internal surface shape of the funnel tube 4. The fourth combined section which is the adjacent scoop 5 of the component structure 5D goes hand-in-hand with extended and connected flat square 6 surface section of the component structure 6E which has a top end straight line edge 6a section. The adjacent scoop 5 which has angle-cut edge 5a, it is like semi-elliptical shape opening which allows flowing liquid material to be seen before it gets to the connected flat square 6 surface of the section 6E that is an important area in liquid paint material for a paint pouring artist, and finally the extended and connected flat square 6 surface section 6E which has a top end straight line edge 6a section, is a main integral section of this whole invention which as by changing the shapes, patterns, designs and styles of the top straight line edge 6a section of the flat square 6 the outcome result of pouring flowable materials will change accordingly.

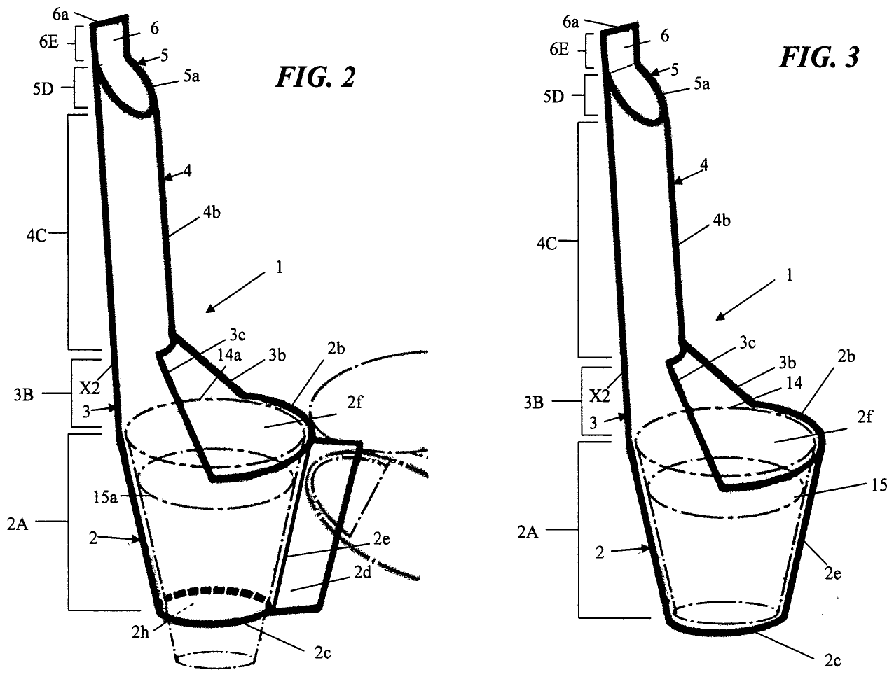

FIG. 2 similar to FIG. 1 that is showing a device 1 which is made of five vertically extended and connected components as follows; a vertical cup container section 2A, a vertical semi-cone shaped funnel section 3B, a vertical cylinder funnel section 4C, and a vertical top adjacent scoop section 5D along with an extended flat square surface section 6E which has a top end straight line edge 6a section, which is all made in a one-piece-single-unit device 1, except one of the extended and connected components which is the vertical cup container 2 section 2A which is modified with a vertical cup container 2 component structure 2A which is made with a hollow tube 2, with ring-shaped side wall 2e, with a bottom end 2c which is opened 2h that is the part which is modified to the bottom end opening 2h and the top end 2f to some extent open and easy to get to place a disposable cup 14a with the flowable material 15a inside the vertical cup container's hollow tube 2 and over all the vertical cup container component structure section 2A is having circumferential dimension with wider ring-shaped portion shown near to the top opening edge 2b of the vertical cup container 2 of the component section 2A and with a narrower ring-shaped portion shown near to the bottom opened 2h end edge 2c of the vertical cup container 2 of the component section 2A which is also having an extended and connected off-vertical flat parallelogram shape handle 2d which starts from the top opening 2f edge 2b to the bottom opened end 2h edge 2c of the vertical cup container 2 component section 2A, which is the vertical cup container 2 section 2A is extended and connected to the vertical semi-cone shape funnel 3 component structure 3B, so wherein with modifying the bottom opened end 2h edge 2c of the vertical cup container 2 of the component section 2A allows longer disposable cup 14a being displaced with more liquid material 15a.

FIG. 3 similar to FIG. 1 that is showing a device 1 which is made of five vertically extended and connected components as follows; a vertical cup container section 2A, a vertical semi-cone shaped funnel section 3B, a vertical cylinder funnel section 4C, and a vertical top adjacent scoop section 5D along with an extended flat square surface section 6E which has a top end straight line edge 6a section, which is all made in a one-piece-single-unit device 1, except one of the extended and connected components which is the vertical cup container 2 section 2A which is modified with a vertical cup container 2 component structure 2A which is made with a hollow tube 2, with ring-shaped side wall 2e, with the bottom end 2c which is closed and the top end 2f to some extent open and easy to fit into place a disposable cup 14 with flowable material 15 inside the vertical cup container's hollow tube 2 and over all the vertical cup container 2 component structure section 2A is having circumferential dimension with wider ring-shaped portion shown near to the top opening 2f edge 2b of the vertical cup container 2 component section 2A and with a narrower ring-shaped portion shown near the bottom closed end edge 2c of the vertical cup container 2 of the component section 2A without a handle which it was 2d which is shown in FIG. 1 that is the part which is modified, so wherein by taking away the extended and connected off-vertical flat parallelogram shape handle 2d of the vertical cup container 2 component section 2A which is shown in FIG. 1 is different than the cup container component section 2A without the handle which is shown in the FIG. 3.

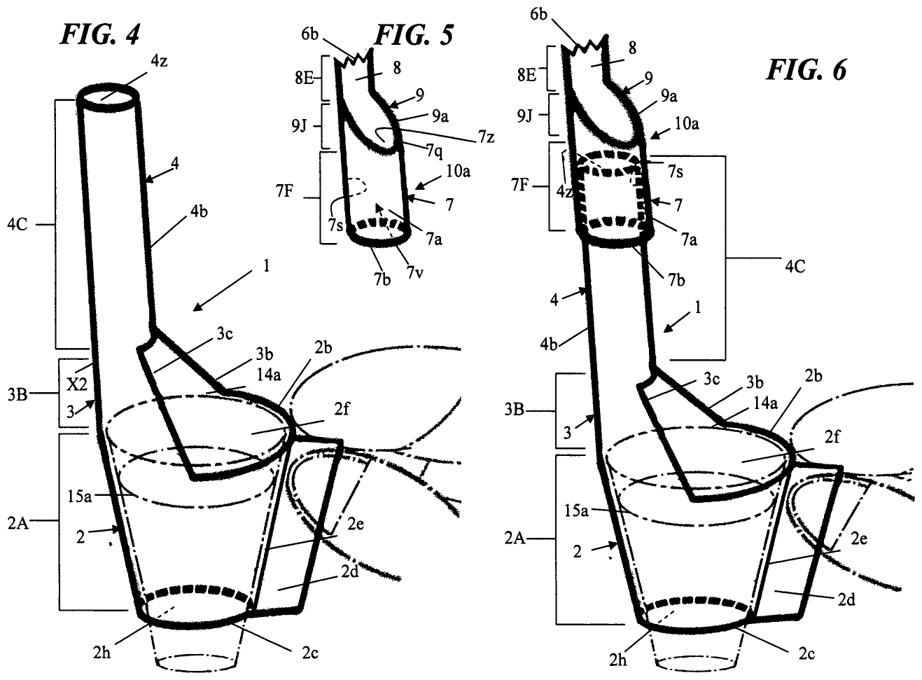

FIG. 4 similar to FIG. 1 that is showing a device 1 which is made of three vertically extended and connected components as follows; a vertical cup container section 2A, a vertical semi-cone shaped funnel section 3B and a vertical cylinder funnel section 4C, except two of the extended and connected components are modified which are made up of a vertical cup container 2 component structure 2A and a vertical top adjacent scoop 5 section 5D along with an extended flat square surface 6 section 6E which has a top end straight line edge 6a section, which is a vertical cup container 2 component structure 2A that is made with a hollow tube 2, with a ring-shaped side wall 2e, with a bottom opened end 2h edge 2c which is opened 2h and that is the part which is modified to the bottom end opening 2h and top end 2f to some extent open and easy to get to place a disposable cup 14a with flowable material 15a inside the vertical cup container's hollow tube 2 and over all the vertical cup container 2 of the component structure section 2A which is having a circumferential dimension with a wider ring-shaped portion shown near the top opening 2f edge 2b of the vertical cup container 2 of the component section 2A and with a narrower ring-shaped portion shown near the bottom opened 2h end edge 2c of the vertical cup container 2 component section 2A which is also having an extended and connected off-vertical flat parallelogram shape handle 2d which starts from the top opening 2f edge 2b to the bottom opened 2h end edge 2c of the vertical cup container 2 component section 2A, which is the vertical cup container 2 section 2A and is extended and connected to the vertical semi-cone shape funnel 3 component structure 3B, and with a top first opening end 4z of the vertical cylinder funnel 4 component structure section 4C, without being vertically and integrally connected to the vertical adjacent scoop 5 component section 5D along with an extended and connected flat square surface 6 section 6E which has a top end straight line edge 6a section, which is shown in FIG. 1.

FIG. 5 referring to the attachable second scoop funnel head 10a which is made up of a vertical second cylinder shape funnel 7 with a wall body 7a, with a hollow vertical cylinder shape tube 7 and having a linear central axis of a vertical second cylinder tube 7 which is comprised by an even ring-shaped side wall body 7a and a centered on axis, with a top first opening end 7z of the second vertical funnel 7 section 7F and, a bottom second opening end 7v of the second vertical funnel 7 section 7F of the attachable second scoop funnel 10a being open to define two unobstructed exit openings 7v and 7z of the attachable second scoop funnel head 10a, which with a top end of the attachable second scoop 9 funnel 7 head 10a a body wall 7a portion vertically and integrally which is made by connected to the vertical adjacent scoop 9 component structure section 9J along with an extended and a connected top end flat square 8 of section 8E, which has a straight series of a connected top end evenly spaced and sized beveled edge 6b section.

FIG. 6 referring to FIG. 4 and FIG. 5 can be combined together which is shown in FIG. 6 by showing with the top end opening 4z of a vertical funnel 4 with a body wall 4b of the vertical cylinder funnel component structure section 4C is coupled and disposed within an attachable second scoop 9 funnel 7 head 10a which is comprised with a connected vertical funnel 7 component structure section 7F and a vertical adjacent scoop 9 component structure section 9J along with an extended and a connected top end flat square 8 section 8E, which has a straight series of a connected top end evenly spaced and sized beveled edge 6b, that both vertical cylinder shaped funnel 4 wall body 4b of the vertical cylinder funnel section 4C and an attachable second scoop 9 funnel 7 wall body 7a of the attachable second scoop head 10a are supported by each other's bodies 4b and 7a during the coupling function by having the same circumferential dimension shape and therefore, there is no gap between the outer shaped vertical funnel 4 wall body 4b and the inner surface body 7s of an attachable second scoop 9 funnel 7 head 10a.

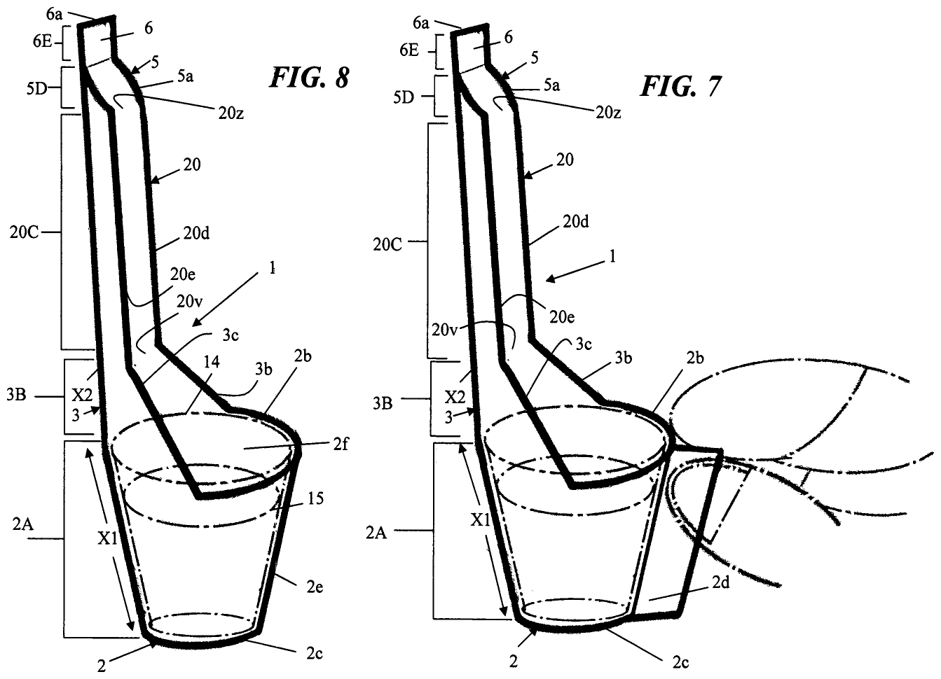

FIG. 7 similar to FIG. 1 that is showing a device 1 which is made of five vertically extended and connected components as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made in a one-piece-single-unit device 1, except one of the extended and connected components which is the vertical cylinder funnel 4 section 4C which is modified with a vertical semi-cylinder funnel 20 component structure section 20C, with a hollow vertical semi-cylinder shape tube 20, which is modified from the cylinder shape tube 4 to a semi-cylinder shape tube 20, having a linear central axis of the vertical semi-cylinder tube 20 which is comprised by a semi-ring-shaped side wall body 20d centered on an axis, and having a semi-cylinder even circumferential dimension of axis, with a top first opening end 20z of a vertical semi-cylinder funnel 20 and, a second bottom opening end 20v of a vertical semi-cylinder funnel 20 being open to define an unobstructed exit openings of the vertical semi-cylinder funnel 20 body wall 20d component structure section 20C, which with a top end 20z of a vertical semi-cylinder funnel 20 body wall 20d portion vertically and integrally connected to the vertical adjacent scoop 5 body wall 5a along with an extended and a connected to a flat square 6 surface section 6E which has a top end straight line edge 6a section, and also X2 of the transition semi-cone funnel back common body wall, of the semi-cylinder funnel 20 back common body wall, and of an adjacent scoop 5 back common body wall along with the extended and connected to a flat square 6 surface section 6E which has a top end straight line edge 6a section, which is having and made by one extended and connected vertical straight even component structure common body wall X2, but cup container body wall X1 is having and made by an extended and a connected off-vertical straight major component structure back body wall X1, so wherein with modifying the vertical cylinder funnel 4 of the component structure section 4C which is shown in FIG. 1, it is different than the vertical semi-cylinder funnel 20 of the component structure section 20C which is shown in FIG. 7.

FIG. 8 similar to FIG. 1 that is showing a device 1 which is made up of five vertically extended and connected components as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made in a one-piece-single-unit device 1, except two of the extended and connected components which are a vertical cup container 2 section 2A and the vertical cylinder funnel 4 section 4C which are modified, first with a vertical cup container 2 component structure 2A which is made with a hollow tube 2, with a ring-shaped side wall 2e, with a bottom end 2c which is closed and a top end 2f to some extent open and easy to fit into place a disposable cup 14 with the flowable material 15 inside the vertical cup container's hollow tube 2 and over all the vertical cup container 2 component structure section 2A while having the circumferential dimension with a wider ring-shaped portion shown nearer to the top opening edge 2b of the vertical cup container 2 component section 2A and with a narrower ring-shaped portion shown nearer to the bottom closed end edge 2c of the vertical cup container component section 2A without a handle 2d which is shown in FIG. 1, which is the part that is modified, and a second modification is with a vertical semi-cylinder funnel 20 component structure section 20C, with a hollow vertical semi-cylinder shape tube 20, which is also modified from a cylinder 4 to a semi-cylinder shape tube 20, having a linear central axis of the vertical semi-cylinder tube 20 which is comprised by a semi-ring-shaped side wall body 20d centered on its axis, and having a semi-cylinder even circumferential dimension of axis, with the top first opening end 20z of the vertical semi-cylinder funnel 20 and second bottom opening end 20v of vertical semi-cylinder funnel 20 being open to define two unobstructed exit openings of the vertical semi-cylinder funnel 20 body wall 20d of the component structure section 20C, which with the top end 20z of the vertical semi-cylinder funnel body wall 20d portion vertically and integrally connected to the vertical adjacent scoop 5 body wall 5a with an extended and connected to a flat square 6 surface section 6E which has a top end straight line edge 6a, and also X2 of a transition semi-cone funnel back common body wall, of a semi-cylinder funnel back common body wall, and of an adjacent scoop back common body wall with an extended and a connected to a flat square 6 surface section 6E which has a top end straight line edge 6a section, which is made by one extended and connected vertical straight even component structure common body wall X2, but cup container body wall X1 is having and made by an extended and a connected off-vertical straight major component structure back body wall X1, without handle 2d which is shown in FIG. 1, this is the part which is modified, so wherein by taking away the extended and connected off-vertical flat parallelogram shape handle 2d of the vertical cup container 2 of the component structure section 2A which is shown in FIG. 1, which is different than the cup container 2 of the component structure section 2A without the handle 2d which is shown in FIG. 8 and also with modifying the vertical cylinder funnel 4 of the component structure section 4C which is shown in FIG. 1, which is different than the vertical semi-cylinder funnel 20 of the component structure section 20C which is shown in FIG. 8.

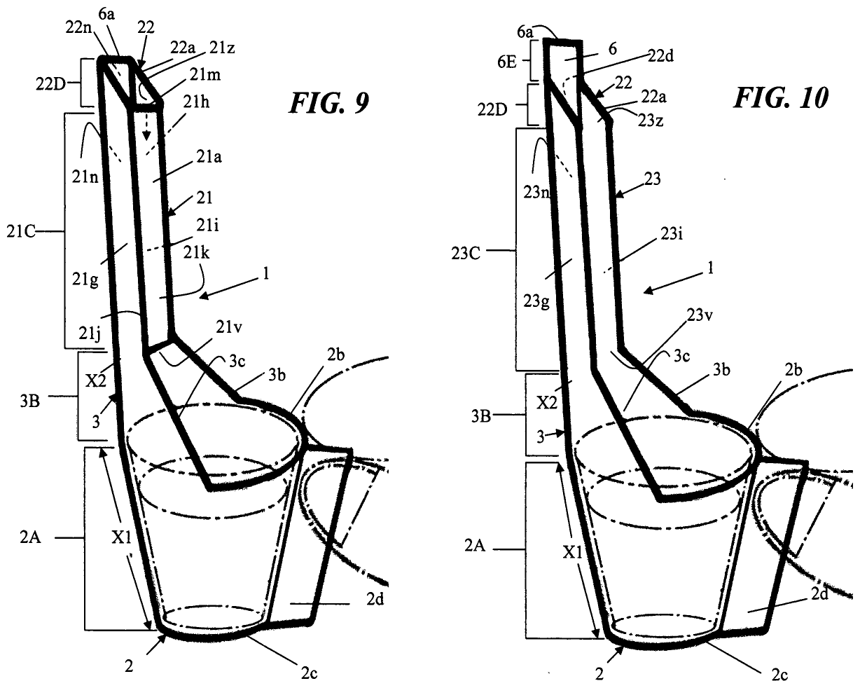

FIG. 9 similar to FIG. 1 that is showing a device 1 which is made up of five vertically extended and connected components as follows; a vertical cup container section 2A, a vertical semi-cone shaped funnel section 3B, a vertical cylinder funnel section 4C, and a vertical top adjacent scoop section 5D along with an extended flat square surface section 6E which has a top end straight line edge 6a section, which is all made in a one-piece-single-unit device 1, except three of the extended and connected components which are a vertical cylinder funnel 4 section 4C and a vertical top adjacent scoop 5 section 5D along with extended flat square 6 surface section 6E which has a top end straight line edge 6a section, which are modified with a vertical rectangular-prism shaped funnel 21 of a component structure section 21C, with a hollow 21m vertical open-end-rectangular-prism shape tube 21 which is modified from a cylinder shape tube 4 which is shown in FIG. 1, having four side walls 21a, 21h, 21g, 21n that is comprised by two minor and equal opposite side walls 21h, 21g and two major and equal opposite side walls 21n, 21a, with a first top opening end 21z of the vertical rectangular-prism shaped funnel 21, and with the funnel bottom opening end 21v of a vertical rectangular-prism shaped funnel 21 being open to define two unobstructed exit openings 21z, 21v of a vertical rectangular-prism shaped funnel 21 of the component structure section 21C, which with the end of a vertical rectangular-prism shaped funnel body walls 21a, 21h, 21g, 21n portion vertically and integrally connected to the vertical rectangular-prism adjacent scoop 22 of the component structure section 22D that is having a top end straight line edge 6a section, which is modified from a cylinder shape adjacent scoop 5 of the component structure section 5D without an extended a top end flat square 6 surface section 6E that is shown in FIG. 1 which is modified and also the transition semi-cone funnel back common body wall X2, a rectangular-prism shaped funnel back common body wall 21n and a rectangular-prism adjacent scoop 22 back common body wall 22n which is having and is made by one extended and a connected vertical straight even component structured body walls X2, 21n and 22n; so wherein by modifying the vertical cylinder funnel 4 component structure section 4C which is shown in FIG. 1 is different than the vertical rectangular-prism shaped funnel 21 component structure section 21C which is shown in FIG. 9, and also with modifying the vertical cylinder funnel section 4C which results to the modification of the adjacent scoop 5 section 5D along with an extended flat square 6 surface section 6E which has a top end straight line edge 6a section, which is shown in FIG. 1 is different than the vertical rectangular-prism adjacent scoop 22 section 22D which has a top end straight line edge 6a section, and without having an extended flat square 6 surface section 6E which is shown in the FIG. 9.

FIG. 10 is similar to FIG. 1 which is showing the device 1 which is made up of five vertically extended and connected components as follows; a vertical cup container section 2A, a vertical semi-cone shape funnel section 3B, a vertical cylinder funnel section 4C, and a vertical top adjacent scoop section 5D along with an extended flat square 6 surface section 6E which has a top end straight line edge 6a section, which is all made in a one-piece-single-unit device 1, except with two of the extended and connected components which are the vertical cylinder funnel 4 section 4C and the vertical top adjacent scoop 5 section 5D that is shown in FIG. 1 which are modified with a vertical staple shape funnel 23 of the component structure section 23C, with a hollow vertical open-end staple shape tube 23, that has three side walls 23i, 23g, 23n which is comprised by two minor and equal opposite side walls 23i, 23g and one major floor side wall 23n with the top first staple shaped opening end 23z of the staple shape funnel 23 and a second staple shape bottom opening end 23v of the staple shape funnel 23 being open to define two unobstructed exit openings 23v, 23z of a staple shape funnel 23 component structure section 23C, which with the end of a vertical staple shaped funnel body walls 23i, 23g, 23n in portions vertically and integrally connected to the vertical adjacent scoop 22 section 22D along with an extended flat square 6 surface section 6E which has a top end straight line edge 6a, and also a transition semi-cone funnel back common body wall X2, a staple shape funnel common body wall 23n and a vertical staple shape adjacent scoop back common body wall 22d of the vertical staple shape adjacent scoop 22 section 22D along with an extended flat square 6 surface section 6E which has a top end straight line edge 6a, which is having and made by one extended and a connected vertical straight even of the component structured common body walls X2, 23n and 22d, the common body walls portion vertically and integrally connected to of the vertical adjacent scoop 22 along with an extended flat square 6 surface section 6E which has a top end straight line edge 6a section, so wherein by modifying a vertical cylinder funnel 4 component structure section 4C which is shown in FIG. 1 which is different than the vertical staple shape funnel 23 of the component structured section 23C which is shown in FIG. 10, and also with modifying the vertical cylinder funnel section 4C which results in modification of the adjacent scoop 5 section 5D along with an extended flat square 6 surface section 6E which has a top end straight line edge 6a section, which is shown in FIG. 1 is different than the vertical staple shape adjacent scoop 22 section 22D along with an extended flat square 6 surface section 6E which has a top end straight line edge 6a section, which is shown in FIG. 10.

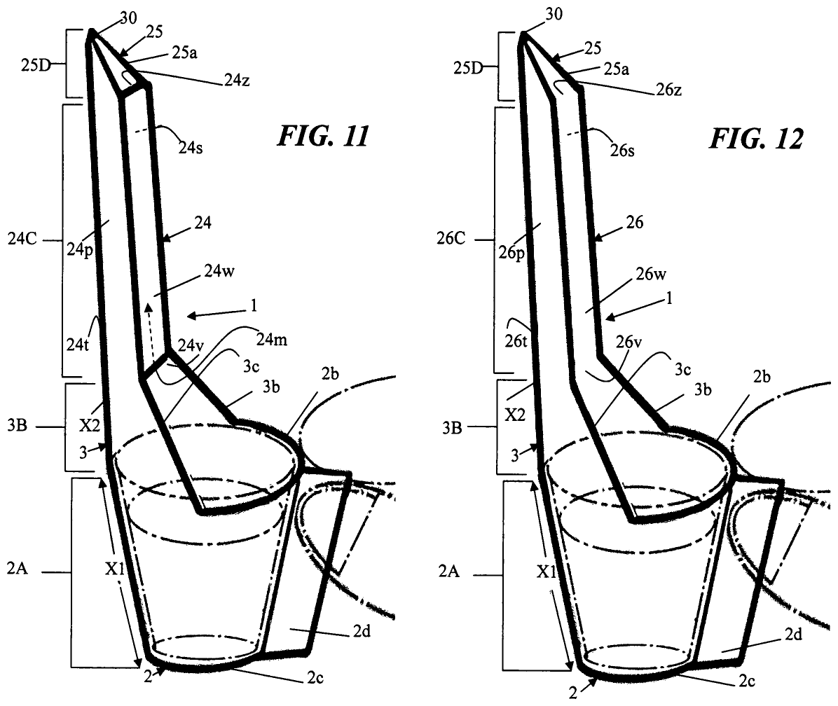

FIG. 11 similar to FIG. 1 that is showing the device 1 which is made up of five vertically extended and connected components as follows; a vertical cup container section 2A, a vertical semi-cone shaped funnel section 38, a vertical cylinder funnel section 4C, and a vertical top adjacent scoop section 5D along with an extended flat square 6 surface section 6E which has a top end straight line edge 6a section, which is all made in a one-piece-single-unit device 1, except for three of the extended and connected components which are in the vertical cylinder funnel 4 section 4C and the vertical top adjacent scoop 5 section 5D along with an extended flat square 6 surface section 6E which has a top end straight line edge 6a section, that is shown in FIG. 1 which is modified with a vertical triangular-prism shaped funnel 24 of the component structure section 24C, with a hollow vertical 24m open-end triangular-prism tube 24 that is modified from a cylinder shaped tube 4, which is having three rectangular side walls 24w, 24p, 24s with one side wall 24w and is positioned in a face-to-face with a vertical cup container handle 2d and V-shape angle edge 24t is facing away from cup container handle 2d and also three rectangular side walls 24w, 24p, 24s are parallel with the center of the cup container 2 compartment axis, with the top first opening base end 24z of the vertical triangular-prism shape funnel 24 and the second triangular-prism shape funnel 24 with the bottom opening base end 24v of the vertical triangular-prism shape funnel 24 being open to define two unobstructed exit openings 24v and 24z of the vertical triangular-prism shape funnel 24 of the component structure section 24C, which with the end of vertical triangular-prism shaped funnel 24 with body walls 24w, 24p, 24s portion vertically and integrally connected to the vertical triangular shape opening end adjacent scoop 25 of the component structure section 25D which has a top end V shape pointed tip 30 section, and also transition semi-cone funnel 3 back body wall X2, the triangular-prism shaped funnel 24 body walls V-shape angle side edge line 24t and triangular shape opening end 25a adjacent scoop 25 section 25D which has a top end V shape pointed tip 30 section which has and is made by one extended and connected vertical straight even of the component structure body walls X2 and 24t, but a vertical cup container 2 body wall X1 which has and is made by an extended and connected off-vertical straight component structure body wall, so wherein by modifying the vertical cylinder funnel 4 of the component structure section 4C which is shown in FIG. 1 which is different than the vertical triangular-prism shaped funnel 24 of the component structure section 24C which is shown in FIG. 11, and also with modifying the vertical cylinder funnel 4 section 4C which results to the modification of the adjacent scoop 5 section 5D along with an extended flat square 6 surface section 6E which has a top end straight line edge 6a section, which is shown in FIG. 1 is different than the vertical triangular shape opening end adjacent scoop 25 of the component structure section 25D which has a top end V shape pointed tip 30 section which is shown in FIG. 11.

FIG. 12 similar to FIG. 1 that is showing a device 1 which is made up of five vertically extended and connected components as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made in a one-piece-single-unit device 1, except three of the extended and connected components which are in the vertical cylinder funnel 4 section 4C and in the vertical top adjacent scoop 5 section 5D along with an extended flat square 6 surface section 6E which has a top end straight line edge 6a section, which are modified with a vertical V-shape funnel 26 of the component structure 26C, with a vertical open-end V-shape tube 26 which is modified from a cylinder shape tube 4, having two rectangular side walls 26p and 26s, with an opening side wall 26w is positioned in a face-to-face with a vertical cup container handle 2d and a V-shape angle edge 26t facing away from cup container handle 2d, with V-shaped rectangular side walls 26p and 26s are parallel with the center of the cup container 2 compartment axis, with the top first opening base end 26z of the vertical V-shape funnel 26 and the second V-shape funnel 26 bottom opening base end 26v of the vertical V-shape funnel 26 being open to define two unobstructed exit openings 26v and 26z of the vertical V-shape funnel 26 of the component structured section 26C, which with the end of vertical V-shape funnel body walls 26p and 26s portion vertically and integrally connected to the vertical V-shape opening end 25a of an adjacent scoop 25 section 25D which has a top end V shape pointed tip 30 section, and also a transition semi-cone funnel 3 back body wall X2, V-shape angle funnel 26 body wall edge 26t and V-shape angle funnel opening end 25a adjacent scoop 25 section 25D which has a top end V shape pointed tip 30 section which has and is made by one extended and connected vertical straight even component structure body walls X2, 26t, but a vertical cup container 2 body wall X1 and is having and made by an extended and connected off-vertical straight component structure body wall, so wherein by modifying the vertical cylinder funnel 4 of the component structure section 4C which is shown in FIG. 1 is different than the V-shape funnel 26 of the component structure section 26C which is shown in FIG. 12, and also with modifying the vertical cylinder funnel 4 section 4C which results to the modification of the adjacent scoop 5 section 5D along with an extended flat square 6 surface section 6E which has a top end straight line edge 6a section, which is shown in FIG. 1 is different than the vertical V-shape opening end 25a of an adjacent scoop 25 of the component structure section 25D which has a top end V shape pointed tip 30 section which is shown in FIG. 12.

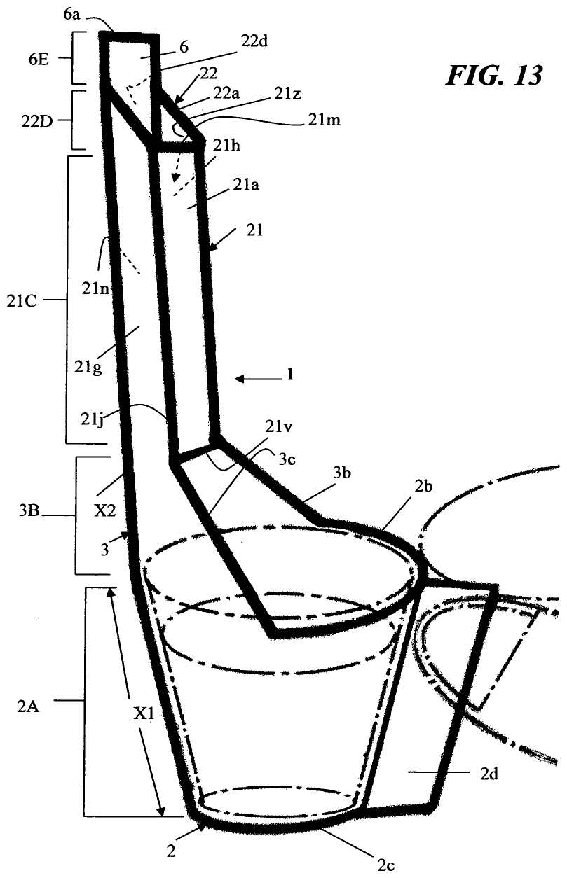

FIG. 13 similar to FIG. 1 that is showing the device 1 which is made up of five vertically extended and connected components are as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made into a one-piece-single-unit device 1, except two of the extended and connected components which is the vertical cylinder funnel 4 section 4C and vertical top adjacent scoop 5 section 5D that is shown in FIG. 1 which is modified with a vertical rectangular-prism shaped funnel 21 of the component structure section 21C, with a hollow 21m vertical open-end rectangular-prism shape tube 21 which is modified from a cylinder shape tube 4, having four side walls 21a, 21h, 21g, 21n and is comprised by two minor and equal opposite side walls 21h, 21g and two major and equal opposite side walls 21n, 21a, with a top first opened end 21z of the vertical rectangular-prism shaped funnel 21, and with the funnel bottom opened end 21v of the vertical rectangular-prism shaped funnel 21 being open to define two unobstructed exit openings 21z, 21v of the vertical rectangular-prism shaped funnel 21 of component structure section 21C, which with the end of the vertical rectangular-prism shaped funnel body walls 21a, 21h, 21g, 21n portion vertically and integrally connected to the vertical rectangular-prism adjacent scoop 22 of the component structure section 22D along with an extended flat square 6 surface section 6E which has a top end straight line edge 6a section, which is modified from the cylinder shape, adjacent scoop 5 of component structure section 5D along with an extended flat square 6 surface section 6E which has a top end straight line edge 6a section, and also transition semi-cone funnel back body wall X2, a rectangular-prism shaped funnel back body wall 21n and a rectangular-prism adjacent scoop 22 back body wall 22d and extended flat square surface section 6 which has and is made by a one extended and connected vertical straight even component structured body walls X2, 21n, 22d, and 6, so wherein by modifying the vertical cylinder funnel 4 of the component structure section 4C which is shown in FIG. 1 which is different than the vertical rectangular-prism shaped funnel 21 of the component structure section 21C and is shown in FIG. 13, and also with modifying the vertical cylinder funnel 4 section 4C which results in modification of the adjacent scoop 5 section 5D along with an extended flat square 6 surface section 6E which has a top end straight line edge 6a section, which is shown in FIG. 1 is different than the vertical rectangular-prism adjacent scoop 22 section 22D along with an extended flat square 6 surface section 6E which has a top end straight line edge 6a section, which is shown in FIG. 13.

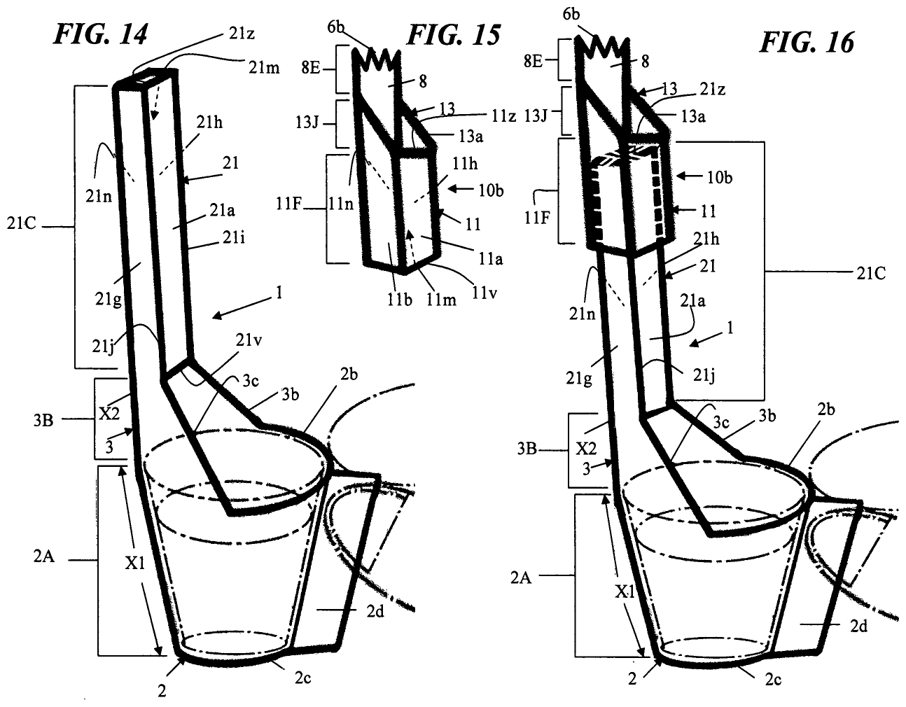

FIG. 14 similar to FIG. 1 that is showing the device 1 which is made up of five vertically extended and connected components are as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made into a one-piece-single-unit device 1, except with three of the extended and connected components which are the vertical cylinder funnel 4 section 4C, and vertical top adjacent scoop 5 section 5D along with an extended flat square 6 surface section 6E which has a top end straight line edge 6a section, that is shown in FIG. 1 which are modified with a vertical rectangular-prism shaped funnel 21 of the component structure section 21C, with a hollow 21m vertical open-end-rectangular-prism shape tube 21 which is modified from a cylinder shape tube 4, and having four side walls 21a, 21h, 21g, 21n which is comprised by two minor and equal opposite side walls 21h, 21g and two major and equal opposite side walls 21n, 21a, with the top first opening end 21z of the vertical rectangular-prism shaped funnel 21, and with the funnel bottom opening end 21v of the vertical rectangular-prism shaped funnel 21 being open to define two unobstructed exit openings 21z, 21v of the vertical rectangular-prism shaped funnel 21 of the component structure section 21C, and with the top first opening end 21z of the vertical rectangular-prism shaped funnel 21 of the component structure section 21C, without being vertically and integrally connected to the vertical adjacent scoop component section 5D along with an extended flat square 6 surface section 6E which has a top end straight line edge 6a section, which is shown in FIG. 1 that is modified, so wherein by modifying the vertical cylinder funnel 4 of the component structure section 4C which is shown in FIG. 1 is different than the vertical rectangular-prism shaped funnel 21 of the component structure section 21C which is shown in FIG. 14, and also with modifying the vertical cylinder funnel section 4C along with an extended flat square 6 surface section 6E which has a top end straight line edge 6a section, which is shown in FIG. 1 is different than without having the vertical adjacent scoop section 5D along with an extended flat square 6 surface section 6E which has a top end straight line edge 6a section, which with both of the modifications are shown in FIG. 14.

FIG. 15 referring to the attachable second scoop funnel head 10b which is made up of a vertical rectangular-prism shaped funnel 11 of the component structure section 11F, with a hollow 11m vertical open-end-rectangular-prism shape tube 11, and having four side walls 11a, 11b, 11h, 11n which are comprised by two minor and equal opposite side walls 11h, 11b and two major and equal opposite side walls 11n, 11a, with a top first opening end 11z of the attachable second scoop funnel head 10b, and with the funnel bottom opening end liv of the attachable second scoop funnel head 10b being open to define two unobstructed exit openings 11z, 11v of the attachable second scoop funnel head 10b, with which the top end of the attachable second scoop funnel head body walls 11a, 11b, 11h, 11n portion are vertically and integrally connected to the vertical adjacent scoop 13 component structure section 13J along with an extended flat square 6 surface section 6E which has a straight series of a connected top end evenly spaced and sized beveled edge 6b section.

FIG. 16 referring to FIG. 14 and FIG. 15 can be combined together which is shown in FIG. 16 by showing with the top end opening 21z of the vertical funnel 21 with the body walls 21a, 21h, 21g, 21n of the vertical rectangular-prism shaped funnel 21 component structure section 21C of a one-piece-single-unit device 1 and is coupled and disposed within an attachable second scoop funnel head 10b which is comprised with a connected vertical rectangular-prism shaped funnel 11 component structure section 11F and a vertical adjacent scoop 13 component structure section 13J along with an extended flat square 8 surface section 8E which has a straight series of a connected top end evenly spaced and sized beveled edge 6b section, that are both vertical rectangular-prism shaped funnel 21 wall bodies 21a, 21h, 21g, 21n of the vertical rectangular-prism shaped funnel section 21C of the one-piece-single-unit device 1 and an attachable second scoop funnel 13 wall bodies 11a, 11b, 11h, 11n of the attachable second scoop head 10b are supported by each other of the bodies 21a, 21h, 21g, 21n and 11a, 11b, 11h, 11n during the coupling functions with having the same circumferential dimension shape and there is not a gap between the outer shaped vertical funnel 21 wall bodies 21a, 21h, 21g, 21n and the inner surface bodies 11a, 11b, 11h, 11n of an attachable second scoop funnel head 10b.

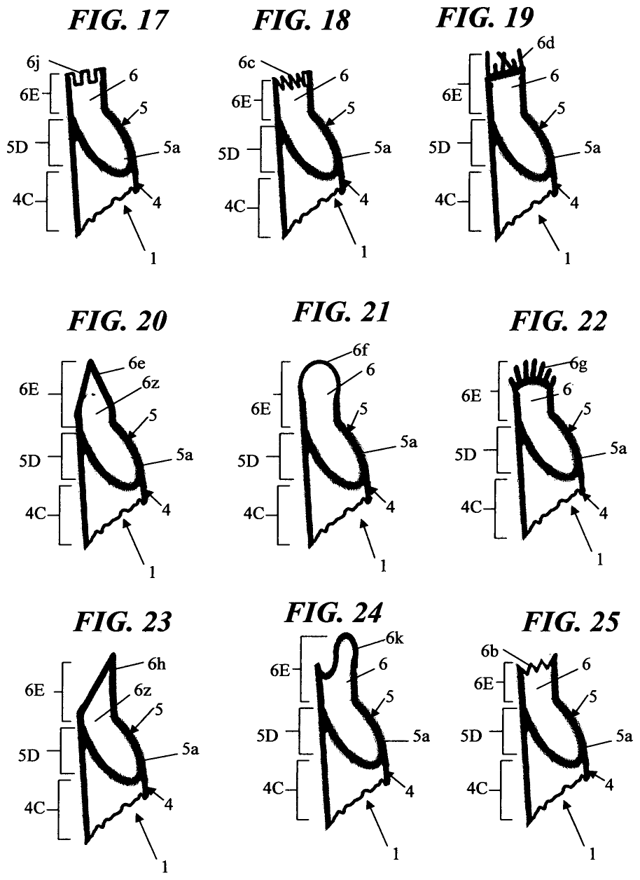

FIG. 17 through FIG. 25 referring to FIG. 1 which is made up of and with an adjacent scoop 5 of the component structure section 5D goes hand-in-hand with an extended flat square 6 surface section 6E which has a top end straight line edge 6a section, of that, which has a top end straight line edge 6a section and can be made with an extended and connected top end flat square 6 surface of the component structure section 6E which has a straight series of a connected top end evenly spaced and sized square angled edge 6j section, it is shown in FIG. 17; and can be made with an extended and connected top end flat square 6 surface section of the component structure section 6E which has a straight series of a connected top end evenly spaced and sized chisel beveled edge 6c section, it is shown in FIG. 18; and can be made with an extended and connected top end flat square 6 surface section of the component structure section 6E which has a protruding series of a top end evenly spaced, unevenly sized and unorganized strip edge 6d section, it is shown in FIG. 19; and can be made with an extended and connected top end flat semi-square 6z surface of the component structure section 6E which has an extended top end single bevel edge 6e section, it is shown in FIG. 20; and can be made with an extended and connected top end flat square 6 surface of the component structure section 6E which has an extended top end semi-circle edge 6f section, it is shown in FIG. 21; and can be made with an extended and connected top end flat square 6 surface of the component structure section 6E which has an extended top end semi-circle edge section along with a protruding fan shape series of a top end evenly spaced, unevenly sized, and organized strip edge 6g section, it is shown in FIG. 22; and can be made with an extended and connected top end flat semi-square 6z surface of the component structure section 6E which has an extended top end single chisel bevel edge 6h section, it is shown in FIG. 23; and can be made with an extended and connected top end flat square 6 surface of the component structure section 6E which has an extended top end wave shaped line edge 6k section, it is shown in FIG. 24; and finally, it can be made with an extended and connected top end flat square 6 surface of the component structure section 6E which has a straight series of a connected top end evenly spaced and sized beveled edge 6b section, it is shown in FIG. 25.

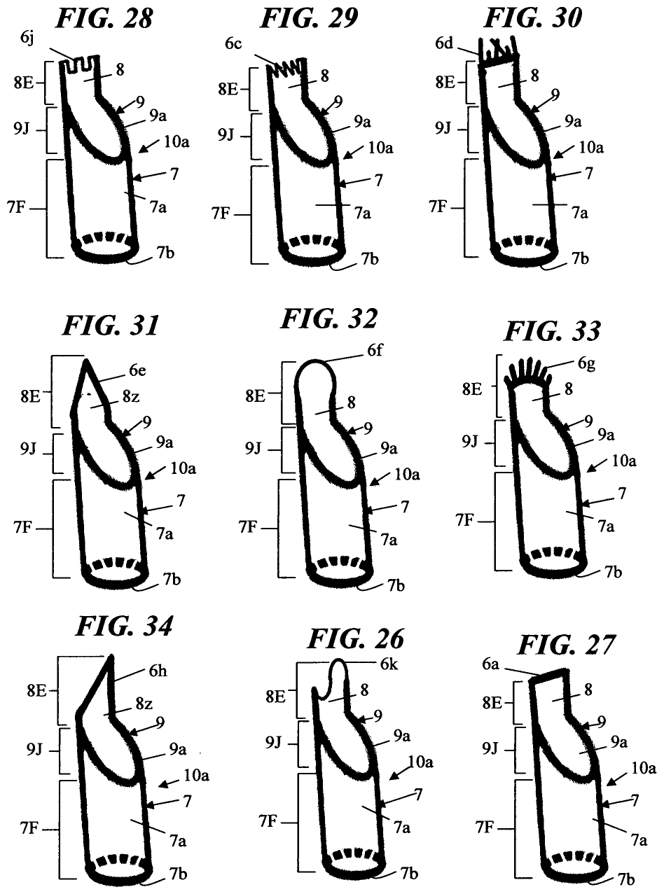

FIG. 26 through FIG. 34 referring to FIG. 5 which is made up of an attachable second scoop funnel head 10a which consists of three component structure sections of the second vertical funnel 7 section 7F, and the vertical adjacent scoop 9 section 9J along with an extended and connected top end flat square 8 surface section 8E, which has a straight series of a connected top end evenly spaced and sized beveled edge 6b section of the component structures that goes hand in hand as one attachable second scoop funnel head 10a unit which is having the straight series of a connected top end evenly spaced and sized beveled edge 6b section, and can be made with an extended and connected top end flat square 8 surface of the component structure section 8E which has an extended top end wave shaped line edge 6k section, it is shown in FIG. 26; and can be made with an extended and connected top end flat square 8 surface of the component structure section 8E which has a top end straight line edge 6a section, it is shown in FIG. 27; and can be made with an extended and connected top end flat square 8 surface of the component structure section 8E which has a straight series of a connected top end evenly spaced and sized square angled edge 6j section, it is shown in FIG. 28; and can be made with an extended and connected top end flat square 8 surface of the component structure section 8E which has a straight series of a connected top end evenly spaced and sized chisel beveled edge 6c section, it is shown in FIG. 29; and can be made with an extended and connected top end flat square 8 surface of the component structure section 8E which has a protruding series of a top end evenly spaced, unevenly sized and unorganized strip edge 6d section, it is shown in FIG. 30; and can be made with an extended and connected top end flat semi-square 8z surface of the component structure section 8E which has an extended top end single bevel edge 6e section, it is shown in FIG. 31; and can be made with an extended and connected top end flat square 8 surface of the component structure section 8E which has an extended top end semi-circle edge 6f section, it is shown in FIG. 32; and can be made with an extended and connected top end flat square 8 surface of the component structure section 8E which has an extended top end semi-circle edge section along with a protruding fan shape series of a top end evenly spaced, unevenly sized, and organized strip edge 6g section, it is shown in FIG. 33; and finally, can be made with an extended and connected top end flat semi-square 8z surface of the component structure section 8E which has an extended top end single chisel bevel edge 6h section, it is shown in FIG. 34.

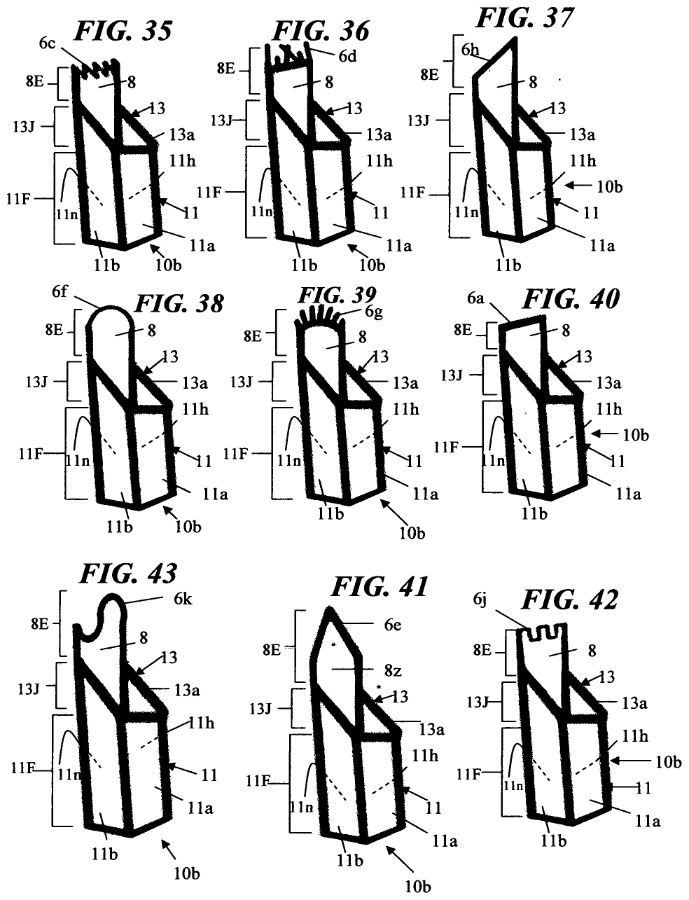

FIG. 35 through FIG. 43 referring to FIG. 15 which is made up of an attachable second rectangular-prism shape scoop funnel head 10b which is made up of three component structure sections of the second vertical funnel 11 section 11F, and the vertical adjacent scoop 13 section 13J along with an extended and connected top end flat square 8 surface section 8E, which has a straight series of a connected top end evenly spaced and sized beveled edge 6b section of the component structures that goes hand in hand as a second rectangular-prism shape scoop funnel head 10b unit which has a straight series of a connected top end evenly spaced and sized beveled edge 6b section, and can be made with an extended and connected top end flat square 8 surface of the component structure section 8E which has a straight series of a connected top end evenly spaced and sized chisel beveled edge 6c section, it is shown in FIG. 35; and can be made with an extended and connected top end flat square 8 surface of the component structure section 8E which has a protruding series of a top end evenly spaced, unevenly sized and unorganized strip edge 6d section, it is shown in FIG. 36; and can be made with an extended and connected top end flat square 8 surface of the component structure section 8E which has an extended top end single chisel bevel edge 6h section, it is shown in FIG. 37; and can be made with an extended and connected top end flat square 8 surface of the component structure section 8E which has an extended top end semi-circle edge 6f section, it is shown in FIG. 38; and can be made with an extended and connected top end flat square 8 surface of the component structure section 8E which has an extended top end semi-circle edge section along with a protruding fan shape series of a top end evenly spaced, unevenly sized, and organized strip edge 6g section, it is shown in FIG. 39; and can be made with an extended and connected top end flat square 8 surface of the component structure section 8E which has a top end straight line edge 6a section, it is shown in FIG. 40; and can be made with an extended and connected top end flat semi-square 8z surface of the component structure section 8E which has an extended top end single bevel edge 6e section, it is shown in FIG. 41; and can be made with an extended and connected top end flat square 8 surface of the component structure section 8E which has a straight series of a connected top end evenly spaced and sized square angled edge 6j section, it is shown in FIG. 42; and finally, can be made with an extended and connected top end flat square 8 surface of the component structure section 8E which has an extended top end wave shaped line edge 6k section, it is shown in FIG. 43.

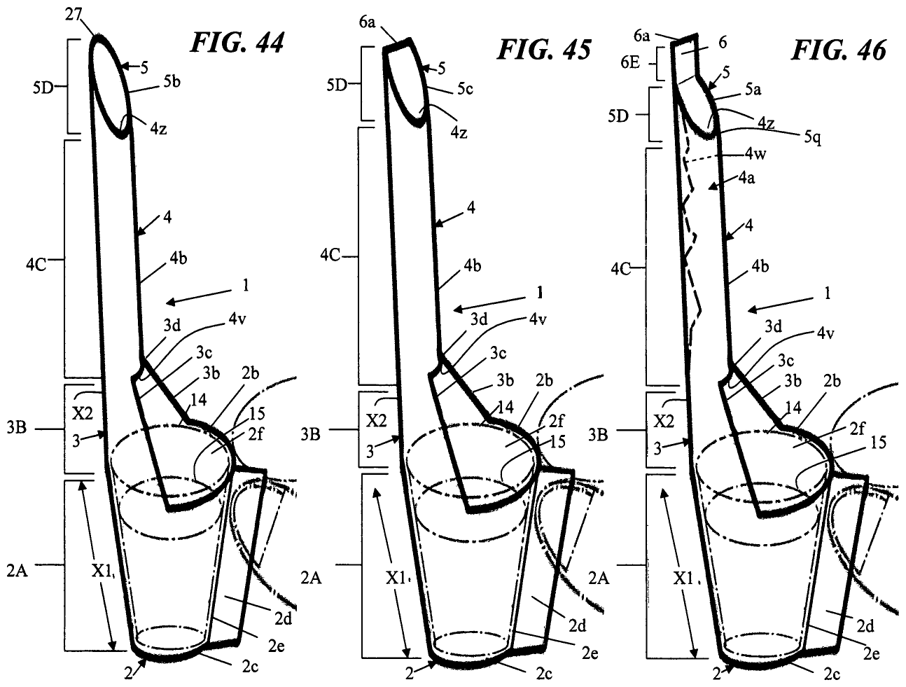

FIG. 44 similar to FIG. 1 that is showing device 1 which is made up of five vertically extended and connected components are as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made in one-piece-single-unit device 1, except two of the extended and connected the components which are the vertical top adjacent scoop 5 of component structure section 5D along with an extended flat square 6 surface section 6E which has a top end straight line edge 6a section, which is modified with a vertical top full-elliptical shaped 5b adjacent scoop 5 section 5D which has a top end curved line edge 27 without having the extended flat square 8 surface section 6E with a top end straight line edge 6a, it is shown in FIG. 1, which is a vertical cup container component structure 2A and is made with a hollow tube 2, with a ring-shaped side wall 2e, with a bottom end 2c which is closed and a top end 2f to some extent open and easy to get and to place a disposable cup 14 with flowable material 15 inside the vertical cup container's hollow tube 2 and over all in the vertical cup container component structure section 2A while having a circumferential dimension with the wider ring-shaped portion shown near to the top opening edge 2b of the vertical cup container's component section 2A and with a narrower ring-shaped portion shown near to the bottom closed end edge 2c of the vertical cup container's component section 2A which also has an extended and connected off-vertical flat parallelogram shape handle 2d which starts from the top opening edge 2b to the bottom closed end edge 2c of the vertical cup container component section 2A, which the vertical cup container section 2A is extended and connected to the vertical semi-cone shape funnel 3 component structure 3B, and the with top first opening end 4z of the vertical cylinder funnel 4 of the vertical cylinder funnel component structure section 4C, while being vertically and integrally connected to the vertical adjacent scoop 5 component section 5D with a full-elliptical opened 5b which has a top end curved line edge 27 section that is modified from the extended and connected to flat square surface 6 section 6E which has a top end straight line edge 6a section, that is shown in FIG. 1, so wherein by modifying a vertical a top adjacent scoop 5 section 5D along with an extended flat square 6 section surface section 6E which has a top end straight line edge 6a section and by taking away the extended flat square 6 surface section 6E which has a top end straight line edge 6a, which is shown in FIG. 1 is different than the vertical adjacent scoop 5 component section 5D with the full-elliptical opened 5b which has a top end curved line edge 27 section which with the modification is shown in FIG. 44.

FIG. 45 similar to FIG. 1 that is showing device 1 which is made up of five vertically extended and connected components are as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made in a one-piece-single-unit device 1, except two of the extended and connected components which are in the vertical top adjacent scoop 5 of the component structure section 5D and in the extended flat square 6 surface section 6E which are modified with a vertical top semi-elliptical shaped 5c adjacent scoop 5 section 5D which has a top end straight line edge 6a section without having the extended flat square 6 surface section 6E with a top end straight line edge 6a and is shown in FIG. 1, which is a vertical cup container component structure 2A and is made up with a hollow tube 2, with a ring-shaped side wall 2e, with a bottom end 2c which is closed and a top end 2f to some extent that is open and easy to get to in which place a disposable cup 14 with flowable material 15 inside the vertical cup container's hollow tube 2 and an overall the vertical cup container component structure section 2A while having a circumferential dimension with the wider ring-shaped portion shown near to the top opening edge 2b of the vertical cup container component section 2A and with a narrower ring-shaped portion shown near to the bottom closed end edge 2c of the vertical cup container component section 2A which also as an extended and connected off-vertical flat parallelogram shape handle 2d which starts from the top opening edge 2b to the bottom closed end edge 2c of the vertical cup container component section 2A, which the vertical cup container section 2A is extended and connected to the vertical semi-cone shape funnel component structure 3B, and with the top first opening end 4z of the vertical cylinder funnel 4 of the vertical cylinder funnel component structure section 4C, while being vertically and integrally connected to the vertical adjacent scoop 5 component section 5D with semi-elliptical opened 5c which has a top end straight line edge 6a section that is modified from the vertical top adjacent scoop 5 section 5D along with an extended flat square 6 surface section 6E which has a top end straight line edge 6a section, which is shown in FIG. 1, so wherein by modifying a vertical top adjacent scoop 5 section 5D along with an extended flat square 6 surface section 6E which has a top end straight line edge 6a section and by taking away the extended vertical top adjacent scoop 5 section 5D with extended flat square 6 section 6E which has a top end straight line edge 6a, which is shown in FIG. 1 is different than vertical adjacent scoop 5 component section 5D with semi-elliptical opened 5c which has a top end straight line edge 6a section which with the modifications are shown in FIG. 45.

FIG. 46 similar to FIG. 1 that is showing device 1 which is made up of five vertically extended and connected components are as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made in a one-piece-single-unit device 1, except one of the extended and connected components which is a vertical cylinder funnel 4 section 4C with a smooth and even internal surface tube which is modified with having an uneven internal surface tube 4w, it is shown in FIG. 1, which has a vertical cylinder shape funnel 4 component structure section 4C which is made with a hollow cylinder shape tube 4 which has a circumferential dimension with having an uneven internal surface 4w portion inside the tube 4 which is modified, and with having top first opening end 4z and also a bottom second opening end 4v which at the bottom second opening end 4v is joined to the vertical semi-cone shape funnel 3 section 3B by the connection of the bottom end opening 3d, and the top first opening end 4z is joined to the adjacent scoop 5 component structure 5D by the connection of the top first opening end 4z to the scoop 5 bottom opening end 5q, so wherein with modifying the vertical cylinder shape funnel 4 component structure 4C and with having a cylinder shape tube 4 from even to uneven internal surface 4w portion inside the tube 4 allows liquid material travel and manipulation of liquid material 15 (in particular liquid paints) can happen by changes in the length, shape of funnel tube 4 and internal surface of the funnel.

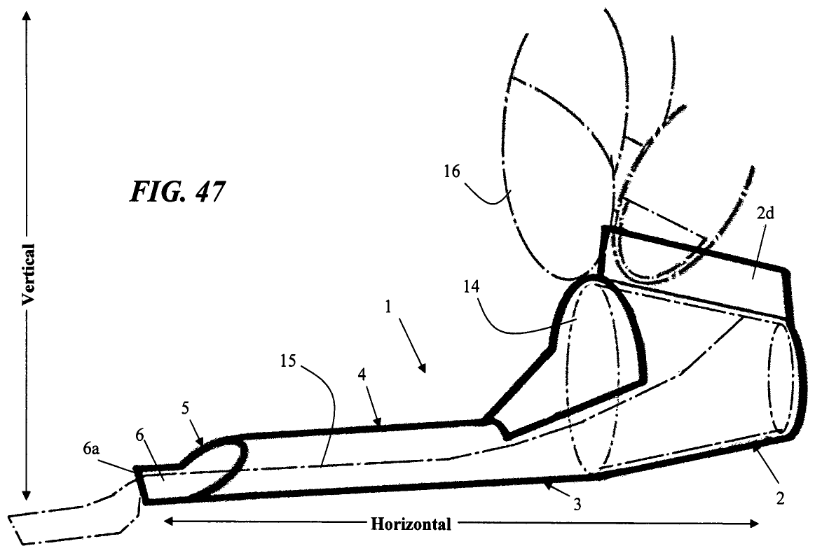

FIG. 47 shows a one-piece-single-unit device 1 in the pouring position of liquid material 15 (in particular liquid paints) from a disposable cup 14 through the tube 4 on the external surface which is placed inside the cup container 2 and also at a horizontal level works as an off and on switch for pouring and gives a high level of control in the liquid paint pouring process.

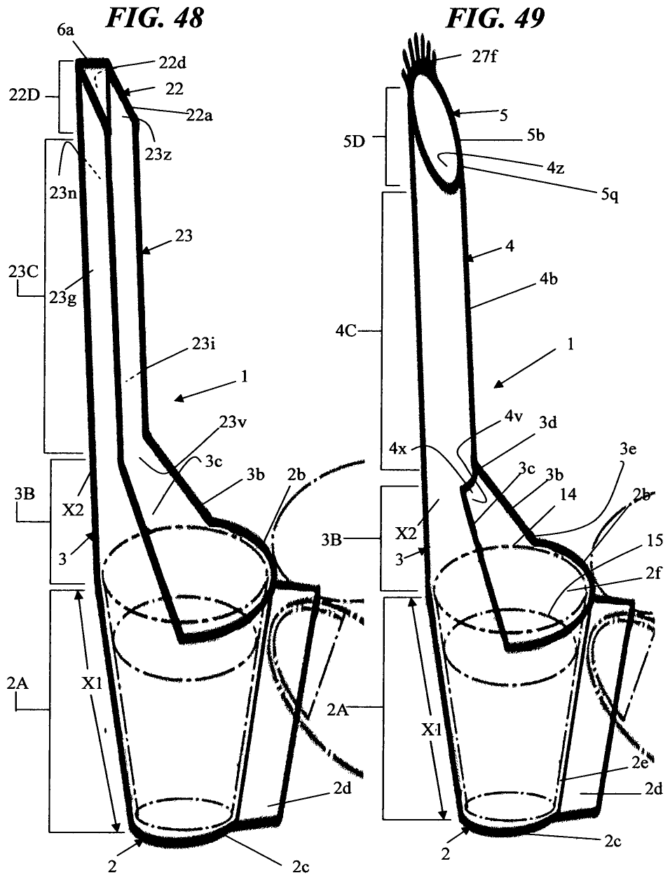

FIG. 48 similar to FIG. 1 that is showing a device 1 which is made up of five vertically extended and connected components are as follows; a vertical cup container section 2A, a vertical semi-cone shaped funnel section 3B, a vertical cylinder funnel section 4C, and a vertical top adjacent scoop section 5D along with an extended flat square 6 surface section 6E which has a top end straight line edge 6a section, which is all made in a one-piece-single-unit device 1, except two of the extended and connected components which is the vertical cylinder funnel section 4C and a vertical top adjacent scoop 5 section 5D which are modified with a vertical staple shaped funnel 23 of the component structure section 23C and a vertical staple shape adjacent scoop 22 section 22D, which is made up of a hollow vertical open-end staple shaped tube 23, and having three side walls 23i, 23g, 23n which is comprised by two minor and equal opposite side walls 23i, 23g and one major floor side wall 23n with a top first staple shape opened end 23z of the staple shape funnel 23 and, a second staple shape bottom opened end 23v of the staple shape funnel 23 being open to define two unobstructed exit openings 23v, 23z of the staple shape funnel 23 component structure section 23C, which with the end of a vertical staple shape funnel body walls 23i, 23g, 23n and portions are vertically and integrally connected to of the vertical staple shape adjacent scoop 22 section 22D which has a top end straight line edge 6a section, and also a transition semi-cone funnel back common body wall X2, a staple shape funnel common body wall 23n and a vertical staple shape adjacent scoop back common body wall 22d of the vertical staple shape adjacent scoop 22 section 22D which has a top end straight line edge 6a section, which has and is made by one extended and connected vertical straight even component structure common body walls X2, 23n and 22d, the common body walls portion are vertically and integrally connected to the vertical staple shape adjacent scoop 22 section 22D which has a top end straight line edge 6a, so wherein by modifying the vertical cylinder funnel 4 component structure section 4C which is shown in FIG. 1 is different than the vertical staple shape funnel 23 of the component structure section 23C which is shown in FIG. 48, and also with modifying the vertical top adjacent scoop 5 section 5D along with an extended flat square 6 surface section 6E which has a top end straight line edge 6a section, which is shown in FIG. 1 is different than the vertical staple shape adjacent scoop 22D without an extended flat square 6 surface section 6E, but with having a top end straight line edge 6a section which is shown in FIG. 48.

FIG. 49 similar to FIG. 1 that is showing device 1 which is made up of five vertically extended and connected components are as follows; a vertical cup container section 2A, a vertical semi-cone shape funnel section 3B, a vertical cylinder funnel section 4C, and a vertical top adjacent scoop section 5D along with an extended flat square 6 surface section 6E which has a top end straight line edge 6a section, which is all made in a one-piece-single-unit device 1, except two of the extended and connected components which are the vertical top adjacent scoop 5 of the component structure section 5D and an extended flat square 6 surface section 6E which are modified, with a vertical adjacent full-elliptical 5b opening shape scoop 5 of section 5D which has a protruding fan shape series of a top end evenly spaced, unevenly sized, and organized strip edge 27f section, which a vertical cup container component structure 2A is made up of a hollow tube 2, with a ring-shaped side wall 2e, with a bottom end 2c which is closed and a top end 2f to some extent open and easy to get to in placing a disposable cup 14 with flowable material 15 inside the vertical cup container's hollow tube 2 and over all the vertical cup container 2 of the component structure section 2A is having a circumferential dimension with a wider ring-shaped portion shown near the top opening edge 2b of the vertical cup container 2 of the component section 2A and with a narrower ring-shaped portion shown near the bottom closed end edge 2c of the vertical cup container 2 of the component section 2A which also has an extended and connected off-vertical flat parallelogram shape handle 2d which starts from the top opening edge 2b to the bottom closed end edge 2c of the vertical cup container 2 of the component section 2A, in which the vertical cup container 2 section 2A is extended and connected to the vertical semi-cone shape funnel 3 of the component structure 3B, and with the top first opening end 4z of the vertical cylinder funnel 4 of the vertical cylinder funnel component structure section 4C, being vertically and integrally connected to a top vertical adjacent full-elliptical Sb opening shape scoop 5 of the component section 5D which has a protruding fan shape series of a top end evenly spaced, unevenly sized, and organized strip edge 27f section, that is modified from the vertical top adjacent semi-elliptical 5a opening shape scoop 5 section 5D along with an extended flat square 6 surface section 6E which has a top end straight line edge 6a section which is shown in FIG. 1, so wherein by modifying a vertical top adjacent semi-elliptical 5a opening shape scoop 5 section 5D along with an extended flat square 6 surface section 6E which has a top end straight line edge 6a section and by taking away the extended flat square surface 6 section 6E which has a top end straight line edge 6a section, which is shown in FIG. 1 is different than vertical adjacent scoop 5 component section 5D with a full-elliptical opened 5b which has a protruding fan shape series of a top end evenly spaced, unevenly sized, and organized strip edge 27f section which with the modification is shown in FIG. 49.

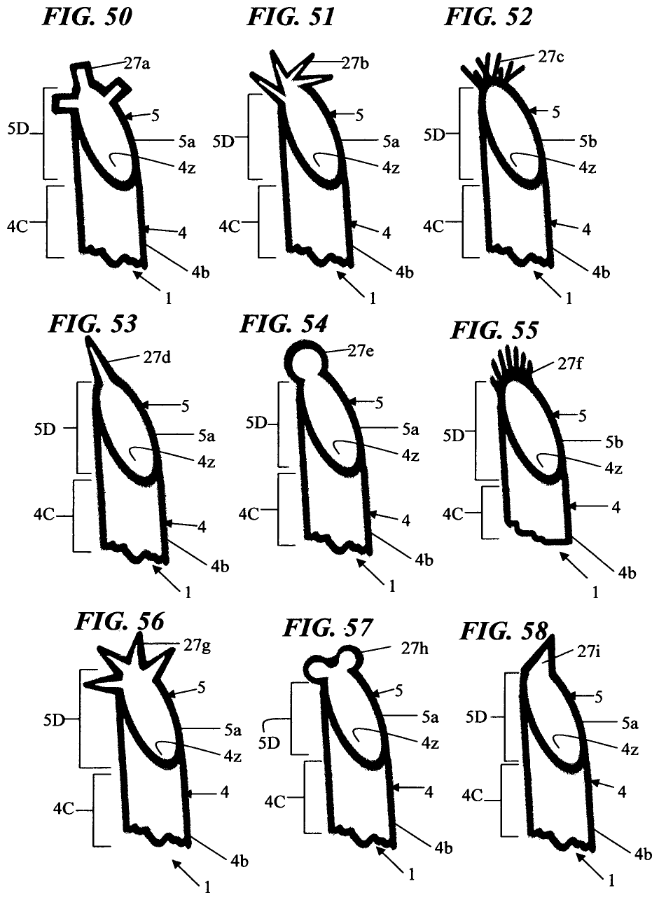

FIG. 50 through FIG. 58 referring to FIG. 1 which is made up of with an adjacent scoop 5 of the component structure section 5D with an incomplete-elliptical opened 5a or a full elliptical shaped opening 5b with the top curve line edge 27 portion goes hand-in-hand of that, which has the top curve line edge 27 portion which can be made with the top vertical adjacent incomplete-elliptical 5a opened scoop 5 of the component section 5D which has an extended fan shape series of a top end evenly spaced and sized square angled edge 27a section, which is shown in FIG. 50; and can be made with the top vertical adjacent incomplete-elliptical 5a opening shaped scoop 5 of the component section 5D which has an extended fan shape series of a connected top end evenly spaced and sized chisel beveled edge 27b section, which is shown in FIG. 51; and can be made with the top vertical adjacent full-elliptical 5b opening shaped scoop 5 of the component section 5D which has a protruding fan shape series of a top end evenly spaced, unevenly sized and unorganized strip edge 27c section, which is shown in FIG. 52; and can be made with the top vertical adjacent incomplete-elliptical 5a opening shaped scoop 5 of the component section 5D which has an extended top end single V shaped bevel edge 27d section, which is shown in FIG. 53; and can be made with the top vertical adjacent incomplete-elliptical 5a opening shaped scoop 5 of the component section 5D which has an extended top end semi-circle edge 27e section, which is shown in FIG. 54; and can be made with the top vertical adjacent full-elliptical 5b opening shaped scoop 5 of the component section 5D which has a protruding fan shape series of a top end evenly spaced, unevenly sized and organized strip edge 27f section, which is shown in FIG. 55; and can be made with the top vertical adjacent incomplete-elliptical 5a opening shaped scoop 5 of the component section 5D which has an extended fan shape series of a connected top end evenly spaced and sized V shaped bevel edge 27g section, which is shown in FIG. 56; and can be made with the top vertical adjacent incomplete-elliptical 5a opening shaped scoop 5 of the component section 5D which has an extended fan shape series of a connected top end evenly spaced and sized wave angle edge 27h section, which is shown in FIG. 57; and finally, can be made with the top vertical adjacent incomplete-elliptical 5a opening shaped scoop 5 of the component section 5D which has an extended top end single chisel bevel edge 27i section, which is shown in FIG. 58.

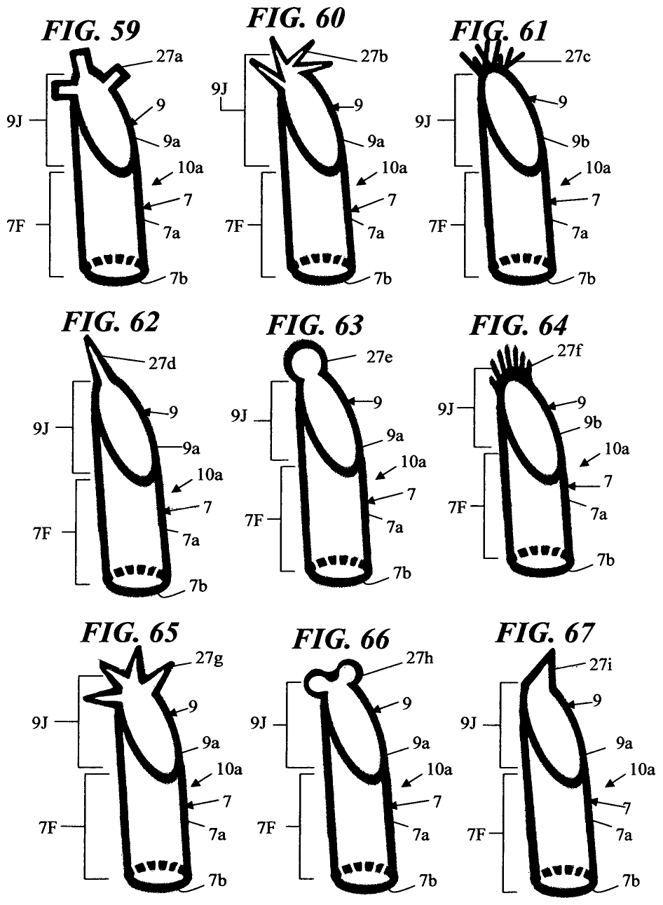

FIG. 59 through FIG. 67 referring to FIG. 5 which is made up of with an attachable second scoop 9 funnel 7 head 10a which comprised of a connected vertical funnel 7 component structure section 7F and a vertical adjacent scoop 9 component structure section 9J with a semi-elliptical shaped opening 9a along with an extended and connected top end flat square 8 surface section 8E which has a straight series of a connected top end evenly spaced and sized beveled edge 6b section, and can be made up of an attachable second scoop 9 funnel 7 head 10a which is comprised with a connected vertical funnel 7 component structure section 7F and a vertical adjacent scoop 9 component structure section 9J with an incomplete-elliptical opened 9a which has an extended fan shape series of a top end evenly spaced and sized square angled edge 27a section, which is shown in FIG. 59; and can be made up of an attachable second scoop 9 funnel 7 head 10a which is comprised with a connected vertical funnel 7 component structure section 7F and a vertical adjacent scoop 9 component structure section 9J with an incomplete-elliptical opened 9a which has an extended fan shape series of a connected top end evenly spaced and sized chisel beveled edge 27b section, which is shown in FIG. 60; and can be made up of an attachable second scoop 9 funnel 7 head 10a which is comprised with a connected vertical funnel 7 component structure section 7F and a vertical adjacent scoop 9 component structure section 9J with a full-elliptical opened 9b which has a protruding fan shape series of a top end evenly spaced, unevenly sized and unorganized strip edge 27c section, which is shown in FIG. 61; and can be made up of an attachable second scoop 9 funnel 7 head 10a which is comprised with a connected vertical funnel 7 component structure section 7F and a vertical adjacent scoop 9 component structure section 9J with an incomplete-elliptical opened 9a which has an extended top end single V shaped bevel edge 27d section, which is shown in FIG. 62; and can be made up of an attachable second scoop 9 funnel 7 head 10a which is comprised with a connected vertical funnel 7 component structure section 7F and a vertical adjacent scoop 9 component structure section 9J with an incomplete-elliptical opened 9a which has an extended top end semi-circle edge 27e section, which is shown in FIG. 63; and can be made up of an attachable second scoop 9 funnel 7 head 10a which is comprised with a connected vertical funnel 7 component structure section 7F and a vertical adjacent scoop 9 component structure section 9J with a full-elliptical opened 9b which has a protruding fan shape series of a top end evenly spaced, unevenly sized and organized strip edge 27f section, which is shown in FIG. 64; and can be made up of an attachable second scoop 9 funnel 7 head 10a which is comprised with a connected vertical funnel 7 component structure section 7F and a vertical adjacent scoop 9 component structure section 9J with an incomplete-elliptical opened 9a which has an extended fan shape series of a connected top end evenly spaced and sized V shaped bevel edge 27g section, which is shown in the FIG. 65; and can be made up of an attachable second scoop 9 funnel 7 head 10a which is comprised with a connected vertical funnel 7 component structure section 7F and a vertical adjacent scoop 9 component structure section 9J with an incomplete-elliptical opened 9a which has an extended fan shape series of a connected top end evenly spaced and sized wave angle edge 27h section, which is shown in FIG. 66; and finally, can be made up of an attachable second scoop 9 funnel 7 head 10a which is comprised with a connected vertical funnel 7 component structure section 7F and a vertical adjacent scoop 9 component structure section 9J with an incomplete-elliptical opened 9a which has an extended top end single chisel bevel edge 27i section, which is shown in FIG. 67.

What is claimed:

1. A one-piece-single-unit device for extracting flowable material particularly liquid paint from a general disposable standard cup in a process of pouring function in particular an artist's pouring with more quality and in quantity control on a detailed pouring and a more precision pouring with creating a variety of designs, textures, patterns, and styles comprising:
a vertical cup container component structure with a hollow tube having a linear central axis of said tube which is comprised by annular and ring-shaped side wall centered on said axis, and having a circumferential dimension of said axis with having a bottom narrow circumferential dimension and a closed end of said vertical cup container component structure along with an extended and connected off-vertical flat parallelogram shaped handle to the cup container's component off-vertical body wall from the cup container's bottom end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of the opening off-vertical wall edge of the said cup container's component structure facing upward, and thereof extended and connected to the vertical semi-cone shape funnel body of said,
vertically semi-cone shape funnel's body component structure with a deep bowl shape and angle cut-way inclined edge body having a top end opening and a bottom end opening of said vertical semi-cone shape funnel, and with having two uneven size end openings of said vertical semi-cone shape funnel, with a narrow opening semi-cone shape funnel being placed on top and a wide opening vertical semi-cone shape funnel being placed on the bottom of said vertical semi-cone shape funnel's body component structure, which is with a semi-cone shape funnel's wide body wall portion vertically and integrally connected to a vertical cup container's top wide circumferential dimension opening end off-vertical body wall from one end of said vertical semi-cone shape funnel body wall, furthermore; vertically and integrally connected to said,
vertical cylinder shape funnel body from the top narrow opening end of the said vertical semi-cone shape funnel body wall from other end, in addition; both of the vertical semi-cone shape funnel's angle cut-way inclined edges extending up and connecting from one end to the top end of the vertical top wide circumferential dimension opening end body wall edge of said cup container opening end body wall edge and from another end to the vertical cylinder shaped funnel's bottom end edge of said vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure with which the top end of the vertical cylinder funnel body wall portion is vertically and integrally connected to said vertical adjacent scoop along with an extended and connected to a flat squared surface section which has a straight-line top end edge section, and also a transition semi-cone funnel back body wall, a cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall;
a general disposable standard cup which contains flowable material being placed inside a vertical cup container component of a one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section of a said one-piece-single-unit device which the off-vertical cup container's handle is being positioned and connected face-to-face with the vertical cylinder funnel on the external surface side of said vertical cup container which is off-vertical and a flat parallelogram shape handle that is connected to the cup container off-vertical body wall from the bottom end edge to the top opening end edge of said cup container off-vertical body wall, by holding entire device along with contained a disposable standard cup which contains the flowable material to the off and on horizontal line level position with minor movement and allows the flowable material in particular liquid paint to move from a disposable standard cup and passes through the semi-cone shape funnel, the funnel tube, and the adjacent scoop and being extracted over the flat squared surface section and the front top end straight-line edge section over the external surface with a great extent of detailed control, precision, and efficiency with creative designs, textures, patterns and styles of pouring liquid in particular liquid paints with the smallest degree of off-and-on horizontal line movements.

2. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat square section which has an extended top end semi-circle edge section.

3. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat semi-square section which has an extended top end single chisel bevel edge section.

4. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat semi-square section which an extended top end single bevel edge section.

5. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat square section which has a straight series of a connected top end evenly spaced and sized beveled edge section.

6. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat square section which a straight series of a connected top end evenly spaced and sized chisel beveled edge section.

7. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat square section which has a straight series of a connected top end evenly spaced and sized square angled edge section.

8. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat square section which has a protruding series of a top end evenly spaced, unevenly sized and unorganized strip edge section.

9. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat square section which has an extended top end semi-circle edge section along with a protruding fan shape series of a top end evenly spaced, unevenly sized, and organized strip edge section.

10. A one-piece-single-unit device according to claim 1, which is made up of a vertical top adjacent scoop along with an extended and connected flat squared surface section which has a straight-line top end edge section can be made up of a vertical top adjacent scoop along with an extended and connected top end flat square section which has an extended top end wave shaped line edge section.

11. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a vertical adjacent full-elliptical opened scoop which has a curve-line top end edge section.

12. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent incomplete-elliptical opened scoop which has an extended top end semi-circle edge section.

13. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent incomplete-elliptical opened scoop which has an extended top end single chisel bevel edge section.

14. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent incomplete-elliptical opened scoop which has an extended top end single V shaped bevel edge section.

15. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent incomplete-elliptical opened scoop which has an extended fan shape series of a connected top end evenly spaced and sized chisel beveled edge section.

16. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent incomplete-elliptical opened scoop which has an extended fan shape series of a top end evenly spaced and sized square angled edge section.

17. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent incomplete-elliptical opened scoop which has an extended fan shape series of a connected top end evenly spaced and sized V shaped bevel edge section.

18. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent incomplete-elliptical opened scoop which has an extended fan shape series of a connected top end evenly spaced and sized wave angle edge section.

19. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent full-elliptical opened scoop which has a protruding fan shape series of a top end evenly spaced, unevenly sized and unorganized strip edge section.

20. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent full-elliptical opened scoop which has a protruding fan shape series of a top end evenly spaced, unevenly sized and organized strip edge section.

21. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent semi-elliptical opened scoop which has a straight line top end edge.

22. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent semi-elliptical opened scoop which has a straight series of a connected top end evenly spaced and sized chisel beveled edge section.

23. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent semi-elliptical opened scoop which has a straight series of a connected top end evenly spaced and sized beveled edge section.

24. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent semi-elliptical opened scoop which has a straight series of a connected top end evenly spaced and sized square angled edge section.

25. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent semi-elliptical opened scoop which has a protruding series of a top end evenly spaced, unevenly sized and unorganized strip edge section.

26. A one-piece-single-unit device according to claim 1, which is made up of a top end of a vertical cylinder funnel body wall portion that is vertically and integrally connected to a vertical adjacent scoop along with an extended and connected to a flat squared surface section which has a straight-line top end edge section can be made up of a top end of a vertical cylinder funnel body wall portion that is vertically and integrally connected to a top vertical adjacent semi-elliptical opened scoop along with an extended top end semi-circle edge section along with a protruding fan shape series of a top end evenly spaced, unevenly sized, and organized strip edge section.

27. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up of a vertical cup container component structure with a hollow tube having a linear central axis of said tube which is comprised by annular and ring-shaped side wall centered on said axis, and having a circumferential dimension of said axis with having a bottom narrow circumferential dimension and a closed end of said vertical cup container component structure along with an extended and connected off-vertical flat parallelogram shaped handle to the cup container's component off-vertical body wall from the cup container's bottom end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of the opening off-vertical wall edge of the said cup container's component structure facing upward can be made up by modifying with a vertical cup container component structure with a hollow tube having a linear central axis of said tube which is comprised by annular and ring-shaped side wall centered on said axis, and having a circumferential dimension of said axis with having a bottom narrow circumferential dimension and an opened end of said vertical cup container component structure along with an extended and connected off-vertical flat parallelogram shaped handle to the cup container's component off-vertical body wall from the cup container's bottom opening end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of the opening off-vertical wall edge of the said cup container's component structure facing upward.

28. A one-piece-single-unit device according to claim 1, which is made up of the off-vertical cup container's handle is being positioned and connected face-to-face with the vertical cylinder funnel on the external surface side of said vertical cup container can be made without any off-vertical cup container's handle on the external surface side of said vertical cup container.

29. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up by modifying with a vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure with which the top end of the vertical cylinder funnel body wall portion is vertically and integrally connected to said vertical adjacent scoop along with an extended and connected to a flat squared surface section which has a straight-line top end edge section, and also a transition semi-cone funnel back body wall, a cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall, can be made up by modifying it with a vertical semi-cylinder funnel component structure, with a hollow vertical semi-cylinder shape tube having a linear central axis of said vertical semi-cylinder tube which is comprised by a semi-annular and semi-ring-shaped side wall centered on said axis, and having a semi-cylinder even circumferential dimension of said axis, with the top first opening end of said vertical semi-cylinder funnel and the second funnel bottom opening end of said vertical semi-cylinder funnel being open to define two unobstructed exit openings of said vertical semi-cylinder funnel component structure with which the top end of the vertical semi-cylinder funnel body wall portion is vertically and integrally connected to said vertical adjacent scoop along with an extended and connected to a flat squared surface section which has a straight-line top end edge section, and also a transition semi-cone funnel back body wall, a semi-cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall.

30. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up by modifying with a vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure with which the top end of the vertical cylinder funnel body wall portion is vertically and integrally connected to said vertical adjacent scoop along with an extended and connected to a flat squared surface section which has a straight-line top end edge section, and also a transition semi-cone funnel back body wall, a cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall, can be made up by modifying it with a vertical rectangular-prism shaped funnel component structure, with a hollow vertical open-end-rectangular-prism tube, having four side walls which are comprised by two minor and equal opposite side walls and two major and equal opposite side walls, with the top first opening end of said vertical rectangular-prism shaped funnel and the second funnel bottom opening end of said vertical rectangular-prism shaped funnel being open to define two unobstructed exit openings of said vertical rectangular-prism shaped funnel component structure with which the top end of the vertical rectangular-prism shaped funnel body wall portion is vertically and integrally connected to said rectangular-prism shaped adjacent scoop along with an extended and connected to a flat squared surface section which has a straight-line top end edge section, and also a transition semi-cone funnel back body wall, a rectangular-prism shaped funnel body wall and a rectangular-prism shaped scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall.

31. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up by modifying with a vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure with which the top end of the vertical cylinder funnel body wall portion is vertically and integrally connected to said vertical adjacent scoop along with an extended and connected to a flat squared surface section which has a straight-line top end edge section, and also a transition semi-cone funnel back body wall, a cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall, can be made up by modifying it with a vertical rectangular-prism shaped funnel component structure, with a hollow vertical open-end-rectangular-prism tube, having four side walls which are comprised by two minor and equal opposite side walls and two major and equal opposite side walls, with the top first opening end of said vertical rectangular-prism shaped funnel and the second funnel bottom opening end of said vertical rectangular-prism shaped funnel being open to define two unobstructed exit openings of said vertical rectangular-prism shaped funnel component structure with which the top end of the vertical rectangular-prism shaped funnel body wall portion is vertically and integrally connected to said rectangular-prism shaped adjacent scoop which has a straight-line top end edge section, and also a transition semi-cone funnel back body wall, a rectangular-prism shaped funnel body wall and a rectangular-prism shaped scoop body wall section which has a straight-line top end edge section which has and is made by a one extended and connected vertical straight even said component structure body wall, but an off-vertical cup container body wall, and has and is made by an extended and connected off-vertical straight component structure body wall.

32. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up by modifying with a vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure with which the top end of the vertical cylinder funnel body wall portion is vertically and integrally connected to said vertical adjacent scoop along with an extended and connected to a flat squared surface section which has a straight-line top end edge section, and also a transition semi-cone funnel back body wall, a cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall, can be made up by modifying it with a vertical staple shaped funnel component structure, with a hollow vertical open-end staple shaped tube, having three side walls which are comprised by two minor and equal opposite side walls and one major floor side wall, with the top first opening end of said vertical staple shaped funnel and the second funnel bottom opening end of said vertical staple shaped funnel being open to define two unobstructed exit openings of said vertical staple shaped funnel component structure with which the top end of the vertical staple shaped funnel body wall portion is vertically and integrally connected to said staple shaped adjacent scoop along with an extended and connected to a flat squared surface section which has a straight-line top end edge section, and also a transition semi-cone funnel back body wall, a staple shaped funnel body wall and a staple shaped scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall.

33. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up by modifying with a vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure with which the top end of the vertical cylinder funnel body wall portion is vertically and integrally connected to said vertical adjacent scoop along with an extended and connected to a flat squared surface section which has a straight-line top end edge section, and also a transition semi-cone funnel back body wall, a cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall, can be made up by modifying it with a vertical staple shaped funnel component structure, with a hollow vertical open-end staple shaped tube, having three side walls which are comprised by two minor and equal opposite side walls and one major floor side wall, with the top first opening end of said vertical staple shaped funnel and the second funnel bottom opening end of said vertical staple shaped funnel being open to define two unobstructed exit openings of said vertical staple shaped funnel component structure with which the top end of the vertical staple shaped funnel body wall portion is vertically and integrally connected to said staple shaped adjacent scoop which has a straight-line top end edge section, and also a transition semi-cone funnel back body wall, a staple shaped funnel body wall and a staple shaped scoop body wall which has a straight-line top end edge section which has and is made by a one extended and connected vertical straight even said component structure body wall, but an off-vertical cup container body wall, and has and is made by an extended and connected off-vertical straight component structure body wall.

34. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up by modifying with a vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure with which the top end of the vertical cylinder funnel body wall portion is vertically and integrally connected to said vertical adjacent scoop along with an extended and connected to a flat squared surface section which has a straight-line top end edge section, and also a transition semi-cone funnel back body wall, a cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall, can be made up by modifying it with a vertical triangular-prism shaped funnel component structure, with a hollow vertical open-end triangular-prism tube, having three rectangular side walls, with one side wall positioned in a face-to-face with a vertical cup container handle and one of the V shape angle facing straight away from cup container handle, also with V shape rectangular side walls parallel with the center of cup compartment axis, with the top first opening base end of said vertical triangular-prism shaped funnel and the second triangular-prism shaped funnel bottom opening base end of said vertical triangular-prism shaped funnel being open to define two unobstructed exit openings of said vertical triangular-prism shaped funnel component structure with which the top end of the vertical triangular-prism shaped funnel body wall portion is vertically and integrally connected to said triangular-prism shaped adjacent scoop which has a top end V shape pointed tip section, and also a transition semi-cone funnel back body wall, a triangular-prism shaped funnel back body wall angle edge and a triangular shaped opening end adjacent scoop back body wall edge which has a top end V shape pointed tip section, which has and is made by a one extended and connected vertical straight even said component structure body wall, but an off-vertical cup container body wall and has and is made by an extended and connected off-vertical straight component structure body wall.

35. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up by modifying with a vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure with which the top end of the vertical cylinder funnel body wall portion is vertically and integrally connected to said vertical adjacent scoop along with an extended and connected to a flat squared surface section which has a straight-line top end edge section, and also a transition semi-cone funnel back body wall, a cylinder funnel body wall and an adjacent scoop body wall along with an extended and connected to a flat squared surface section which has a straight-line top end edge section which has and is made by a one extended and connected vertical straight even said component structure body wall, but an off-vertical cup container body wall, and has and is made by an extended and connected off-vertical straight component structure body wall, can be made up by modifying it with a vertical V shaped funnel component structure, with a hollow vertical open-end V-shaped tube, having two rectangular side walls, with an opening side without a wall is positioned in a face-to-face with a vertical cup container handle and a V-shaped angle facing away from the cup container handle, with the top first opening base end of said vertical V shaped funnel and the second V shaped funnel bottom opening base end of said vertical V shaped funnel being open to define two unobstructed exit openings of said vertical V shaped funnel component structure with which the top end of the vertical V shaped funnel body wall portion is vertically and integrally connected to said V shaped adjacent scoop which has a top end V shape pointed tip section, and also a transition semi-cone funnel back body wall, a V shaped funnel back body wall angle edge and a V shaped opening end adjacent scoop back body wall edge which has a top end V shape pointed tip section, which has and is made by a one extended and connected vertical straight even said component structure body wall, but an off-vertical cup container body wall and has and is made by an extended and connected off-vertical straight component structure body wall.

36. A one-piece-single-unit device which is made up of a connected combination of a vertical cup container with a handle, a vertical semi-cone shape funnel, a vertical cylinder funnel, and a vertical top adjacent scoop along with an extended flat squared surface section which has a straight-line top end edge section, according to claim 1, which is made up by modifying with a vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first opening end of said vertical cylinder funnel and the second funnel bottom opening end of said vertical cylinder funnel being open to define two unobstructed exit openings of said vertical cylinder funnel component structure can be made up by modifying it with a vertical cylinder funnel component structure, with a hollow vertical cylinder shape tube, having a linear central axis of said vertical cylinder and having an uneven internal surface tube which is comprised by an annular and ring-shaped side wall centered on said axis, and having an uneven circumferential dimension of said axis, with the top first opening end of said vertical cylinder funnel and the second funnel bottom opening end of said vertical cylinder funnel being open to define two unobstructed exit openings of said vertical cylinder funnel component structure.

37. A one-piece-single-unit device along with an attachable head comprising:
a vertical cup container component structure with a hollow tube having a linear central axis of said tube which is comprised by annular and ring-shaped side wall centered on said axis, and having a circumferential dimension of said axis with having a bottom narrow circumferential dimension and an opened end of said vertical cup container component structure along with an extended and connected off-vertical flat parallelogram shaped handle to the cup container's component off-vertical body wall from the cup container's bottom end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of the opening off-vertical wall edge of the said cup container's component structure facing upward, and thereof extended and connected to the vertical semi-cone shape funnel body of said,
vertically semi-cone shape funnel's body component structure with a deep bowl shape and angle cut-way inclined edge body having a top end opening and a bottom end opening of said vertical semi-cone shape funnel, and with having two uneven size end openings of said vertical semi-cone shape funnel, with a narrow opening semi-cone shape funnel being placed on top and a wide opening vertical semi-cone shape funnel being placed on the bottom of said vertical semi-cone shape funnel's body component structure, which is with a semi-cone shape funnel's wide body wall portion vertically and integrally connected to a vertical cup container's top wide circumferential dimension opening end off-vertical body wall from one end of said vertical semi-cone shape funnel body wall, furthermore; vertically and integrally connected to said vertical cylinder shape funnel body from the top narrow opening end of the said vertical semi-cone shape funnel body wall from other end, in addition; both of the vertical semi-cone shape funnel's angle cut-way inclined edges extending up and connecting from one end to the top end of the vertical top wide circumferential dimension opening end body wall edge of said cup container opening end body wall edge and from another end to the vertical cylinder shaped funnel's bottom end edge of said vertical cylinder funnel component structure, with a hollow vertical cylinder shape tube having a linear central axis of said vertical cylinder tube which is comprised by an annular and ring-shaped side wall centered on said axis, and having an even circumferential dimension of said axis, with the top first ring shaped opening end of said vertical cylinder funnel and the second funnel bottom opening end of said vertical cylinder funnel being open to define two unobstructed exit openings of said vertical cylinder funnel component structure, furthermore; a transition semi-cone funnel back body wall, a cylinder funnel body wall which has and is made by a one extended and connected vertical straight even said component structure body wall, but an off-vertical cup container body wall, and has and is made by an extended and connected off-vertical straight component structure body wall;
by coupling and disposing within an attachable second scoop cylinder shaped funnel head which is made of a vertical second cylinder shaped funnel body, with a hollow vertical cylinder shape tube having a linear central axis of said vertical second cylinder tube which is comprised by an annular and a ring-shaped side wall centered on said axis, and having an even circumferential dimension of said axis, with a top first opening end of said vertical second cylinder funnel and, a bottom second ring shaped opening end of a second cylinder funnel of said attachable second scoop cylinder shaped funnel being open to define two unobstructed exit openings of said attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section that both vertical cylinder shaped funnel body and an attachable second cylinder shaped scoop funnel head are supported by each other of said bodies, with having the same circumferential dimension shape and there is not a gap between the outer shaped vertical cylinder shaped funnel body and inner surface of an attachable second scoop cylinder shaped funnel head of said bodies,
a general disposable standard cup which contains flowable material being placed inside a vertical cup container component of a one-piece-single-unit device along with an attachable head which the one-piece-single-unit device is made up of a connected combination of a vertical cup container with a handle, a vertical semi-cone shape funnel and a vertical cylinder funnel, and also an attachable second scoop funnel head which is made up of a connected combination of a vertical cylinder funnel, a vertical top adjacent scoop along with an extended and connected a top end flat squared surface section which has a straight series of a connected top end evenly spaced and sized beveled edge section, of said a one-piece-single-unit device along with an attachable head which the cup container's off-vertical handle is being positioned and connected face-to-face with a vertical cylinder funnel along with an attachable head on the external surface side of said cup container's off-vertical body wall which is an off-vertical flat parallelogram shape handle that is connected from the bottom end edge to the top opening end edge of said vertical cup container, and by holding the entire device along with contained a disposable standard cup which contains the flowable material to the off and on horizontal line level position with minor movement and allows the flowable material in particular the liquid paint to move from a disposable standard cup and passes through the semi-cone shape funnel, and cylinder shaped funnel tube, and the attachable second scoop cylinder shaped funnel head and being extracted over the flat squared surface section and the front top end of a straight series of a connected top end evenly spaced and sized beveled edge section over the external surface with great extent of detailed control, precision, and efficiency with creative designs, textures, patterns and styles of pouring liquid in particular liquid paints with the smallest degree of off-and-on horizontal line movements.

38. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight-line top end edge section.

39. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended top end flat semi-square section which has an extended top end single chisel bevel edge section.

40. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended top end flat semi-square section which has an extended top end single bevel edge section.

41. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended top end flat square section which has an extended top end semi-circle edge section.

42. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended top end flat square section which has a straight series of a connected top end evenly spaced and sized chisel beveled edge section.

43. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended top end flat square section which has a straight series of a connected top end evenly spaced and sized square angled edge section.

44. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended top end flat square section which has a protruding series of a top end evenly spaced, unevenly sized and unorganized strip edge section.

45. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended top end flat square section which has an extended top end semi-circle edge section along with a protruding fan shape series of a top end evenly spaced, unevenly sized, and organized strip edge section.

46. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said vertical top adjacent cylinder shaped scoop along with an extended top end flat square section which has an extended top end wave shaped line edge section.

47. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent cylinder shaped full-elliptical opened scoop which has a top end curved line edge section.

48. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent incomplete-elliptical opened scoop which has an extended top end semi-circle edge section.

49. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent incomplete-elliptical opened scoop which has an extended top end single chisel bevel edge section.

50. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent incomplete-elliptical opened scoop which has a straight series of a connected top end evenly spaced and sized chisel beveled edge section.

51. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent incomplete-elliptical opened scoop which has an extended top end single V shaped bevel edge section.

52. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent incomplete-elliptical opened scoop which has an extended fan shape series of a connected top end evenly spaced and sized wave angle edge section.

53. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent incomplete-elliptical opened scoop which has an extended fan shape series of a connected top end evenly spaced and sized V shaped bevel edge section.

54. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent incomplete-elliptical opened scoop which has an extended fan shape series of a top end evenly spaced and sized square angled edge section.

55. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent full-elliptical opened scoop which has a protruding series of a top end evenly spaced, unevenly sized and unorganized strip edge section.

56. A one-piece-single-unit device along with an attachable head, according to claim 37, that is using an attachable second scoop cylinder shaped funnel head, which with the top end of the attachable second scoop cylinder shaped funnel head body wall portion vertically and integrally connected to said vertical top adjacent cylinder shaped scoop along with an extended and connected to a top end flat squared surface section which has a straight series of a connected top end evenly spaced and sized beveled edge section can be made up with an attachable second scoop cylinder shaped funnel head, which with the top end of the attachable second scoop cylinder shaped funnel head body wall portion vertically and integrally connected to said a top vertical adjacent full-elliptical opened scoop which has a protruding fan shape series of a top end evenly spaced, unevenly sized and organized strip edge section.

57. A one-piece-single-unit device which is made of connected combination of a vertical cup container with handle, a vertical semi-cone shape funnel and a vertical cylinder funnel, according to claim 37 which is made up of a vertical cup container component structure with a hollow tube having a linear central axis of said tube which is comprised by annular and ring-shaped side wall centered on said axis, and having a circumferential dimension of said axis with having a bottom narrow circumferential dimension and an opened end of said vertical cup container component structure along with an extended and connected off-vertical flat parallelogram shaped handle to the cup container's component off-vertical body wall from the cup container's bottom end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of the opening off-vertical wall edge of the said cup container's component structure facing upward can be made up by modifying with a vertical cup container component structure with a hollow tube having a linear central axis of said tube which is comprised by annular and ring-shaped side wall centered on said axis, and having a circumferential dimension of said axis with having a bottom narrow circumferential dimension and a closed end of said vertical cup container component structure along with an extended and connected off-vertical flat parallelogram shaped handle to the cup container's component off-vertical body wall from the cup container's bottom end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of the opening off-vertical wall edge of the said cup container's component structure facing upward.

58. A one-piece-single-unit device according to claim 37 which is made up of the off-vertical cup container's handle, which is being positioned in face-to-face with a vertical cylinder funnel and is connected on the external surface side of said vertical cup container off-vertical body and can be made without any extended and connected off-vertical flat parallelogram shape handle which is connected to and from the bottom end edge to the top opening end edge of said vertical cup container off-vertical wall body.

59. A one-piece-single-unit device along with an attachable head comprising:
a vertical cup container component structure with a hollow tube having a linear central axis of said tube which is comprised by annular and ring-shaped side wall centered on of said axis, and having a circumferential dimension of said axis with having a bottom narrow circumferential dimension and a closed end of said vertical cup container component structure along with an extended and connected off-vertical flat parallelogram shaped handle to the cup container's component off-vertical body wall from the cup container's bottom end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of opening off-vertical wall edge of the said cup container's component structure facing upward, and thereof extended and connected to the vertical semi-cone shape funnel body of said,
vertical semi-cone shape funnel's body component structure with a deep bowl shape and angle cut-way inclined edge body having a top end opening and a bottom end opening of said vertical semi-cone shape funnel, and with having two uneven size end openings of said vertical semi-cone shape funnel, with a narrow opening semi-cone shape funnel being placed on top and a wide opening vertical semi-cone shape funnel being placed on the bottom of said vertical semi-cone shaped funnel's body component structure, which is with a semi-cone shape funnel's wide body wall portion vertically and integrally connected to a vertical cup container's top wide circumferential dimension opening end off-vertical body wall from one end of said vertical semi-cone shape funnel body wall, furthermore; from the top narrow opening end of the vertical semi-cone shape funnel body wall from other end, vertically and integrally connected to said vertical rectangular-prism shaped funnel body from the top narrow opening end of the said vertical semi-cone shape funnel body wall from other end, in addition; both of the vertical semi-cone shape funnel's angle cut-way inclined edges extending up and connecting from one end to the top end of the vertical top wide circumferential dimension opening end body wall edge of said cup container opening end body wall edge and from another end to the vertical rectangular-prism shaped funnel's bottom end edge of said, vertical rectangular-prism shaped funnel component structure, with a hollow vertical open-end-rectangular-prism, having four side walls which comprised by two minor and equal opposite side walls and two major and equal opposite side walls, with top first opening end of said vertical rectangular-prism shaped funnel and, second funnel bottom opening end of said vertical rectangular-prism shaped funnel being open to define two unobstructed exit openings of said vertical rectangular-prism shaped funnel component structure; furthermore, a transition semi-cone funnel back body wall, a rectangular-prism shaped funnel back body wall which has and is made by a one extended and connected vertical straight even of said component structure body wall, but an off-vertical cup container body wall, and has and is made by an extended and connected off-vertical straight of said the component structure body wall;
by coupling and disposing within an attachable second scoop rectangular-prism funnel head which is made of a vertical second rectangular-prism shaped funnel body, with a hollow vertical open-end-rectangular-prism having four side walls which comprised by two minor and equal opposite side walls and two major and equal opposite side walls, with top first rectangular shape opening end of said vertical second rectangular-prism shaped funnel and, bottom second rectangular shaped opening end of second rectangular-prism shape funnel of said attachable second rectangular-prism scoop funnel being open to define two unobstructed exit openings of said attachable second scoop rectangular-prism shaped funnel head, which with top end of attachable second scoop rectangular-prism shaped funnel head body wall portion vertically and integrally connected to of said vertical top adjacent rectangular-prism shaped scoop along with an extended and connected to a top end flat squared surface section which has a straight series of a connected top end evenly spaced and sized beveled edge section, that both vertical rectangular-prism shaped funnel body and an attachable second scoop rectangular-prism shaped funnel head are supported by each other of said bodies, with having the same rectangular-prism parameter shape and there is not gap between the outer shaped vertical rectangular-prism shaped funnel body and inner surface of an attachable second scoop rectangular-prism shaped funnel head of said bodies,
a general disposable standard cup which contains a flowable material being placed inside a vertical cup container component of a one-piece-single-unit device along with an attachable head which is made up of a connected combination of a vertical cup container with a handle, a vertical semi-cone shape funnel, and a vertical rectangular-prism shaped funnel, and also an attachable second scoop funnel head which is made up of a connected combination of a vertical rectangular-prism funnel, a vertical top adjacent rectangular-prism scoop with extended and connected top end flat square surface section which has a straight series of a connected top end evenly spaced and sized beveled edge section, of said a one-piece-single-unit device along with an attachable head which the cup container's off-vertical handle is being positioned and connected face-to-face with a vertical rectangular-prism shaped funnel along with an attachable head on the external surface side of said cup container's off-vertical body wall which is an off-vertical flat parallelogram shape handle that is connected from the bottom end edge to the top opening end edge of said vertical cup container, and by holding the entire device along with contained a disposable standard cup which contains the flowable material to the off and on horizontal line level position with minor movement and allows flowable material in particular the liquid paint to move from disposable standard cup and passes through the semi-cone shape funnel, and rectangular-prism shaped funnel tube, and attachable second rectangular-prism shaped scoop funnel head and being extracted over the flat squared surface section and the front top end of a straight series of a connected top end evenly spaced and sized beveled edge section, over external surface with great extent of detailed control, precision, and efficiency with creative designs, textures, patterns and styles of pouring liquid in particular liquid paints with the smallest degree of off-and-on horizontal line movements.

60. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected top end flat squared surface section which has a straight line top end edge section.

61. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended top end flat squared surface section which has an extended top end semi-circle edge section.

62. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended top end flat squared surface section which has an extended top end single chisel bevel edge section.

63. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended top end flat semi-square section which has an extended top end single V shaped bevel edge section.

64. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended top end flat squared surface section which has a straight series of a connected top end evenly spaced and sized square angled edge section.

65. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended top end flat squared surface section which has a protruding series of a top end evenly spaced, unevenly sized and unorganized strip edge section.

66. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended top end flat squared surface section which has an extended top end wave shaped line edge section.

67. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended top end flat square section which has an extended top end semi-circle edge section along with a protruding fan shape series of a top end evenly spaced, unevenly sized, and organized strip edge section.

68. A one-piece-single-unit device along with an attachable head, according to claim 59, that is using an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended and connected to a top end flat squared surface section which has a straight series of a connected top end evenly spaced and sized beveled edge section can be made up with an attachable second scoop rectangular-prism shaped funnel head, which with the top end of the attachable second scoop rectangular-prism shaped funnel head body walls portion vertically and integrally connected to said vertical top adjacent rectangular-prism shaped scoop along with an extended top end flat squared surface section which has a straight series of a connected top end evenly spaced and sized chisel beveled edge section.

69. A one-piece-single-unit device which is made up of a connected combination of a vertical cup container with handle, a vertical semi-cone shape funnel, and a vertical rectangular-prism funnel, according to claim 59 which is made up of a vertical cup container component structure with a hollow tube having a linear central axis of said tube which is comprised by annular and ring-shaped side wall centered on said axis, and having a circumferential dimension of said axis with having a bottom narrow circumferential dimension and a closed end of said vertical cup container component structure along with an extended and connected off-vertical flat parallelogram shaped handle to the cup container's component off-vertical body wall from the cup container's bottom end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of the opening off-vertical wall edge of the said cup container's component structure facing upward can be made up by modifying with a vertical cup container component structure with a hollow tube having a linear central axis of said tube which is comprised by annular and ring-shaped side wall centered on said axis, and having a circumferential dimension of said axis with having a bottom narrow circumferential dimension and an opened end of said vertical cup container component structure along with an extended and connected off-vertical flat parallelogram shaped handle to the cup container's component off-vertical body wall from the cup container's bottom end edge to the cup container's top opening end edge of said cup container's off-vertical wall, by the cup container's end off-vertical wall being a flat transverse wall extending normal to its central axis facing down of said cup container's component structure, and the cup container's top opening end having a wide circumferential dimension with the end of the opening off-vertical wall edge of the said cup container's component structure facing upward.

70. A one-piece-single-unit device according to claim 59 which is made up of the off-vertical cup container's handle, which is being positioned in face-to-face with a vertical rectangular-prism shaped funnel and is connected on the external surface side of said vertical cup container off-vertical body and can be made without any extended and connected off-vertical flat parallelogram shape handle which is connected to and from the bottom end edge to the top opening end edge of said vertical cup container off-vertical wall body.
